(19) United States
(12) Patent Application Publication
(10) Pub. No.: US 2010/0223157 A1
(43) Pub. Date: Sep. 2, 2010

(54) ONLINE VIRTUAL KNOWLEDGE MARKETPLACE

(76) Inventor: Simardip Kalsi, Easton, PA (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/682,821

(22) PCT Filed: Oct. 7, 2008
(86) PCT No.: PCT/US08/79075

§ 371 Date: Apr. 13, 2010

Related U.S. Application Data
(60) Provisional application No. 60/979,899, filed on Oct. 15, 2007.
(60) Provisional application No. 61/087,484, filed on Aug. 8, 2008.

(51) Int. Cl. G06Q 30/00; G06Q 50/00; G06Q 99/00; G06Q 20/00; G06F 17/30; G06F 3/048; G06F 15/16

(52) U.S. Cl. 705/27; 707/752; 707/769; 707/802; 715/777; 709/219; 707/E17.044; 707/E17.014

(57) ABSTRACT

A system and method for providing a virtual knowledge marketplace in the form of an Internet-based on-demand commercial exchange for professional knowledge and services. In one embodiment, the Knowledge Marketplace System is a networked computer system comprising a computerized data processing and communication network operative to exchange data. The system includes a plurality of networked servers including a web applications server which provides an interface portal for Knowledge Consumers and Knowledge Producers to access the system and exchange information. In one embodiment, the system is operative to both receive, organize, and store knowledge content in information packets created by Knowledge Producers in a database, and further operative in turn to enable Knowledge Consumers to search or browse for knowledge content and then purchase the content for viewing at a predetermined price. In one embodiment, the system provides a subscription service enabling Knowledge Consumers to purchase viewing rights to entire topical categories of knowledge content. The system is further operative to financially compensate Knowledge Producers based on the number of times their own knowledge content is purchased by Knowledge Consumers.

### CROSS REFERENCE TO RELATED APPLICATIONS

This application claims the benefit of priority to U.S. Provisional Application No. 60/979,899 filed Oct. 15, 2007 and U.S. Provisional Application No. 61/087,484 filed Aug. 8, 2008, both of which are incorporated herein by reference in their entireties.

### FIELD OF THE INVENTION

The present invention generally relates to a system and method implemented via a computer network for providing an Internet based virtual marketplace for on-demand creation, acquisition, presentation, storage, distribution, selling and trading of knowledge, training and services as commodities.

### BACKGROUND

The Service Sector has undergone exponential growth in the last couple of decades. After the industrial revolution and the manufacturing revolution of the early twentieth century, service sector revolution is the one that has provided the most jobs. It has powered the US economy, and is the dominant player in the overall growth of the global economies. And unlike manufacturing a “Model T Car” that you can keep churning out of the factory, there is very limited standardization in service sector.

The service economy requires a constant up gradation and evolution of the skills for its “Knowledge Worker”. Be it new software and system skills in IT (information technology), skills needed to perform the various business functions impacted by the very implementation of the new IT and/or business systems, new advances in clinical research and Continued Medical Education for physicians, or the changing business-socio legal environment in the legal profession to name a few, the demand for new learning and continuous improvement is constant.

The service sector undergoes tremendous innovation and re-engineering of existing systems, methods, processes, along with dedicated research. It is not surprising that in order to be competent in this industry a knowledge worker must continuously acquire new skills, upgrade or obsolete existing skills and do so rapidly to keep changing alongside the evolving information and the business and economic system he/she is part of. As not doing so makes the knowledge worker's skills redundant and lower his/her economic potential.

At the same token the service sector is rapidly growing and expanding globally in new markets. Everywhere the same methods, systems, and processes are improving and there is a global economy being raised. It means that skills are needed everywhere and not all skills are present everywhere. The U.S. alone, as per U.S. Department of Labor (Bureau of Labor Statistics) forecasts a shortage of 10,033,000 skilled workers by 2010.

Growing economies in Asia and Eastern Europe also need skill sets to fuel their growth. As the new economies emerge and the old economies (in U.S. and Western Europe) mature and further innovate, the need for knowledge worker with the most current skill set grows tremendously. At the same token, the constant expectation for knowledge workers to upgrade and acquire new knowledge, where the half-life for what we know and how we perform tasks is growing shorter. It is tough for everyone to keep pace with this rapidly changing and turbulent service economy.

At the same time, training choices and the ability to rapidly acquire and share knowledge (both general and specific) are limited and cumbersome. For example, formal offsite training incurs prohibitive costs for trainers, business travel, and lost productivity. Organizations implementing enterprise-level LMS (Learning Management Systems) have discovered the huge investments and business commitment required to keep the infrastructure and learning content current. Online classes may reduce costs, but none these methods address the biggest fundamental problem: People don't learn that way.

The existing system of knowledge sharing and accessibility, however, has numerous drawbacks as follows.

On-Demand ‘Just in Time’ Instead of ‘Just in Case’ Professional Training

Almost all training programs teach a particular set of facts ‘just in case’ students might need it. Organized training, including self-paced courses, delivers generalized information about how to accomplish a task or how to use a tool, but there is no context and little company-specific real-world application. In contrast, people learn best when they get training ‘just in time,’ when a specific need develops wherein they can benefit from flexible timing and individual control of the information and knowledge sought.

The practical solution, on-demand knowledge acquisition, happens when professional employees at all levels in an organization call for it, so it's easier for them to make sense of it within their everyday tasks. This is the moment when users' motivation to learn is at its peak . . . when they can maximize understanding by applying it into a real-world task at hand . . . and when they stay within the workplace, maintaining productivity. This approach gives professional employees or “Knowledge Consumers” more meaningful knowledge acquisition and training which lends itself to knowledge retention after the information and skills sought is initially acquired.

Thus given the severe demands placed by service market economy on a global scale, the industry totally lacks a unified, comprehensive, cost-effective, current, relevant, and just-in-time (on-demand) system for on-demand professional training and knowledge acquisition by knowledge workers that is readily adaptable to an rapidly growing and continuously updating knowledge base.

Absence of Defined Product and Service Marketplaces

The existing online information industry also lacks an organized and unified mechanism for service delivery where the buyer of the service can easily determine the options, resources, skills, costs and an overall perspective on the service offerings in a particular space from different competing service vendors. A competitive marketplace is lacking, where buyers can explore and try out various options services and tools before committing to huge investments. The current systems also lack a common platform where Knowledge Producers can commonly sell or demonstrate their respective prowess, and depth and breadth of content knowledge (i.e. expertise). At the same time, Knowledge Consumers or seekers must be able to access an information system in real-time to improve their skills irrespective of geographical location or time of day.

The current knowledge delivery systems also lack a way to give buyers a way to conduct “on-demand” comparison on competing information sources or services, based on past performance, direct customer feedback and ratings, and “Productized Cost” for the defined information service or solution being offered.

In summary, the current knowledge delivery systems do not offer unified and organized information and service delivery marketplaces like the kind that exist in the online retailing and manufacturing sectors. Service economy now outpaces the manufacturing economies of a lot of countries. Yet it is surprising that the knowledge service sector is so fragmented without a much needed unified platform for acquiring knowledge on a real time (on-demand) basis.

The present invention aims to “productize” knowledge services for professionals through a unified Internet-based platform that establishes an organized competitive virtual knowledge marketplace and delivery platform offering features similar to those available to the consumer in the online retailing and manufacturing sectors (e.g. Amazon.com, E-bay, etc.) allowing the Knowledge Consumer to shop for information. The present invention further aims to provide information services to Knowledge Consumers on a real time, on-demand basis.

Poor Value Proposition of Delivered Services

Most areas of the existing knowledge-based service sector are not unified. Even though there are a number of providers, still sometimes even the larger providers do not have the exact expertise and resources that are required for some projects. Therefore, they contract out to subcontractors who further contract down to sub-subcontractors, and so on. In this value chain, there may be a lot of intermediaries or players in between who do not offer any real value to these projects and are there only for taking a cut of the overall sale or contract. In other words, the gap between the skilled worker and the client is linearly pushed out further and further. On the other hand, to satisfy the market demand and because of the large amount of non-value added players involved in between, a lot of clients get a weaker resource skill set for the same invested dollars to offset the payout to lot of non-value added players making it a poor value proposition.

In summary, the existing service provision systems do not provide direct access to “high quality” and “skilled knowledge workers” and their business critical knowledge which is key to innovation and growth in a service economy. The present invention aims to provide a better value proposition for Knowledge Consumers by giving such consumers direct access to a multitude of available Knowledge Producers, thereby eliminating the “middle man.”

Confined Knowledge Delivery System with Limited Re-Use and Recycling

In the knowledge service sector, the spread of knowledge remains confined to an individual or a company the Knowledge Producers or workers interacts with. The concept of recycling and reusing knowledge, and unleashing its full potential to the masses, remain largely untapped. It is because the current systems operate in closed arena, providing access to knowledge only to those who interact with these knowledge providers or producers directly or indirectly, while many others have need for that very same knowledge, information, or skills. For example, there should not be a barrier for anyone to acquire either the skill to become a professionally trained service person or the opportunity to then deliver these skills regardless of geographical boundaries. Once delivered, knowledge-based information, skills, or solutions should be readily accessible to everyone and not need to be recreated each and every time when we have a globally-accessible infrastructure like the Internet.

The present invention aims to avoid the foregoing inefficiencies by offering an Internet based knowledge marketplace and platform that facilitates recycling and reuse of already-created knowledge by making it readily available to other Knowledge Consumers having a similar need for the same information and solutions to the same problems.

Lack of Commoditized Approach and Quality Control Issues

An open and transparent self-organizing system where knowledge can be commoditized, pooled, sold, traded, distributed, and recycled/reused by many Knowledge Consumers and similarly created by many Knowledge Producers is practically non-existent. In recent years, a lot of new initiatives (e.g. Wikipedia, YouTube, Scribd, etc.) moving towards open and self organizing information systems (where knowledge can be pooled, collaborated on, shared and distributed in a self organizing way) have taken place on the Internet. These are now called Web 2.0 companies. While these sites have a role in providing casual information seekers with generalized knowledge, these type information platforms have numerous drawbacks for the business user and do not meet effectively meet their knowledge and/or training needs.

First, the Web 2.0 information platforms are inflexible for the Knowledge Consumer user and not very interactive, and provide no options to the Knowledge Consumer in the type and/or level of detail of information ultimately retrieved. There is basically one content that is delivered or downloaded to the Knowledge Consumer on a given topic which is tantamount to a “one size fits all” approach in information delivery. Second, there is no connectivity with the Knowledge Producers because these known information sites are not interactive and provide no mechanism for Knowledge Producers and Knowledge Consumers to communicate through the Web 2.0 information platforms if answers to queries or content are not already resident in these information site's online databases. Third, the Web 2.0 platforms for the most part operate as a “free” sources for distributing information and do not function like true marketplaces wherein Knowledge Producers or providers can receive monetary compensation for their knowledge/expertise-based information deliveries in a similar way that Internet-based manufacturers and sellers of products currently operate. This is not a competitive information exchange environment which incentivizes Knowledge Producers to be the best based on some correlation in the form of financial compensation. Accordingly, many experienced Knowledge Producers and experts are not inclined to contribute free information to these existing platforms because they are not a “place for doing business.”

Fourth, and significantly, there is no qualification provided to the Knowledge Consumer regarding the relative reliability of the information provided or the Knowledge Producer associated with providing the information on existing Web 2.0 platforms. This inherently creates concerns for information quality by these existing “no-cost” information Web 2.0 platforms which typically lacks any type of quality control over the content they post on the Web. Without some form of quality assurance or gauge, either through third-party qualification of the information and/or Knowledge Producers or user-based feedback/ratings of experiences with various individual Knowledge Producers, the Knowledge Consumers must be wary about the reliability of the “free” information. This is especially pertinent where the information obtained by the Knowledge Consumer may form the be the basis for making important business decisions. The potential financial risks and consequences from relying on the dearth of “free” unqualified information available over the Web today is a major disincentive for businesses to use or rely on information available via Web 2.0 type sites. Accordingly, the free information platforms do not meet the information quality standards demanded by businesses and are more suitable for casual or lay information seekers.

The present invention aims to provide Knowledge Consumers with a cost-effective Internet-based platform for obtaining customized knowledge and training relevant to their specific issue at hand and with at least some indicia of quality and reliability of the information provided and the associated Knowledge Producer.

Lack of Practical Knowledge/Experience Disseminated

“Knowledge” in the true sense of the word in terms of that provided by professional Knowledge Producer embodies both classic text book type information and real world practical experience and tips based on years of actual job experience in a certain field of expertise. This type of practical information is not typically offered to a large extent by existing “free” Web 2.0 type information platforms or systems that are more heavily weighted towards text book type information.

The present invention aims to allow the Knowledge Consumer to obtain true professional “knowledge” combining both text book and real world practical information for implementing business solutions in a manner which avoids the pitfalls not traditionally treated in text book type information alone.

Lack of Integrating all Types of Professional Information and Training Services

The needs of professional Knowledge Consumers who may also be professional Knowledge Producers themselves are not effectively or efficiently met at present. There presently is a lack of a single comprehensive Web-based platform that allows Knowledge Consumers to both obtain information and advice on various specific topics, in addition to obtaining access to on-demand professional training required to maintain skill sets for the professional. Currently, there are numerous separate online training sites and numerous separate online information databases all residing at numerous different web addresses which is inefficient to the time conscious professional and cumbersome to search for the desired information and/or training.

The present invention aims to provide an integrated knowledge marketplace and Web portal to the professional Knowledge Consumer which provides access to both information and online training services.

Burdensome Formal Service Contracts

In order to obtain “business quality” advice and knowledge from professional Knowledge Producers or consultants, the traditional model has been to contract individuals or organizations to provide the information and services required on a piece-meal basis. Many hours of lost productivity and expense results from first searching for and contacting professionals with the requisite technical expertise, formalizing the engagement via a service contract, and then administering the contract. The overhead costs for the Knowledge Consumer, be it an individual or business, are sometimes not commensurate with the amount of information or services needed. Accordingly, the existing process of obtaining professional services and knowledge is cumbersome and expensive.

The present invention aims to provide a more cost effective solution to traditional method of acquiring knowledge and/or professional services which is scalable in efficiencies to the level of detail and scope of the information on a project-by-project basis. Through collecting, organizing, and offering pre-packaged or productized information from a plurality of Knowledge Producers with the ability of the Knowledge Consumer to select and purchase these knowledge packages online, at fixed prices, the present system aims to eliminate the need for the professional Knowledge Consumer to avoid formal service contracts to address topic specific information service needs and training.

Non-Existent Financial System

As noted above, there also seems to be non-existent financial systems with existing information delivery platforms that can provide liquidity in service markets like the kind that exist for manufacturing commodities or products. The knowledge markets are essential to the growth of any economy; for an individual, company, or the nation. However, the current systems lack a platform or financial system where a service-based knowledge marketplace can be created and that allows the knowledge to be traded as yet another commodity or product. The present invention aims to provide an incentivized system wherein Knowledge Producers or providers do not merely “post” information, but rather provide knowledge and information to Knowledge Consumers in exchange for financial competition. This creates a competitive virtual knowledge marketplace in true business sense bringing Knowledge Consumers and Knowledge Producers together.

In summary, an improved web-based virtual knowledge marketplace and financial compensation system is desired that minimizes or eliminates the foregoing drawbacks in the existing knowledge platforms and information delivery systems.

### SUMMARY OF THE INVENTION

The present invention is intended to solve the above inequalities and drawbacks in the existing knowledge and information delivery market by providing an Internet-based virtual “Knowledge Marketplace.” An on-demand Web-based computer implemented system and method is provided which creates a unified Knowledge Marketplace platform to provide and obtain professional knowledge, training, and services of any type, thereby bringing providers and consumers of professional knowledge and services together at a single virtual site or marketplace. This provides an environment where a “Knowledge Producer” or professional provider provides and shares knowledge with a “Knowledge Consumer” in the farm of professional knowledge, training, and/or services in some embodiments.

Furthermore, an embodiment of the present invention provides a financial compensation system for the Knowledge Producer incentivizes the producers, including top experts, to disseminate their knowledge and expertise. Another embodiment of the present invention provides a quality system for gauging the reliability of information offered over the knowledge marketplace so the Knowledge Consumers can make informed decisions based on the information acquired. A professional Knowledge Consumer or seeker can basically (1) access the online Web-based system from virtually anywhere the Internet is available, (2) conduct a search or browse for and obtain specific desired knowledge, training, and/or solution/services, or (3) input a question to ask for the knowledge, training, and/or solution/services if not already available through the knowledge marketplace. This gives the Knowledge Consumer the control over what specific topic to learn as opposed to a traditional “educator driven” generalized training or Learning Management Systems (LMS) models that give such control to educators or trainers. The present invention also advantageously provides for the “just-in-time” knowledge based on-demand service that promotes usage and increases retention of skills as they are searched and acquired when they are needed most at the job.

In one embodiment according to the present invention, an Internet-based on-demand virtual knowledge marketplace system for professionals implemented via a Web-based computer and communication network is provided. The system includes: a host computer network including a database accessible to the network that contains a plurality of pre-packaged information packets browsable via a first remote computer by a knowledge consumer through a Web portal; a communications network linking the first remote computer to the host computer network; each information packet containing information related to a professional topic or subject matter, the information packets comprising at least one each of a first packet associated with a first type of professional knowledge content and a second packet associated with a second type of professional knowledge content, each information packet having an associated purchase price. Preferably, the system is operative to allow the knowledge consumer to preview, select, and purchase an information packet online for viewing in real time over the Internet.

In one embodiment, an Internet-based on-demand virtual Knowledge Marketplace System for professionals implemented via a Web-based computer and communication network is provided. The system includes: a host computer network including a database management server connected to database containing an online knowledge content library storing a plurality of pre-packaged information packets of professional knowledge content browsable via a first remote computer by a knowledge consumer through a Web portal, the information packets being uploaded to the system by a knowledge producer and having an associated viewing price and content type tag designated by the knowledge producer for their respective information packet; and a communications network linking the first remote computer to the host computer network. Preferably, the database management server is operative to: receive a search or browse request from the knowledge consumer; retrieve one or more previews of information packets from the online knowledge content library responsive to the knowledge consumer request; and display the one or more information packet previews in the Web portal to the knowledge consumer with the associated content type tag designation.

In another embodiment, a method implemented by a Web-based computer and communication network for exchanging professional information via the Internet in an online virtual knowledge marketplace is provided. The method includes: providing a host computer and communication network operative to exchange information via the Internet between a plurality of knowledge producers and knowledge consumers; storing in a database accessible to the network a plurality of knowledge content information packets uploaded to the network by a plurality of knowledge producers, each information packet having an associated knowledge content type selected from one of at least two content types and an associated viewing price; receiving a selection request from a knowledge consumer to purchase and view one of the information packets; processing an online payment by the knowledge consumer for the selected information packet; retrieving the selected information packet from the database; and displaying the selected information packet in a Webpage to the knowledge consumer.

In one embodiment, a method implemented by a Web-based computer and communication network for exchanging professional information via the Internet in an online virtual knowledge marketplace is provided. The method includes: providing a host computer and communication network operative to establish two-way communications via the Internet between a plurality of knowledge consumers and professional knowledge producers; receiving a question from a knowledge consumer over the network containing a request for professional knowledge assistance; displaying the question to a plurality of knowledge producers over the network; receiving a knowledge content offering responsive to the question from at least one of the knowledge producers; and transmitting the responsive knowledge content offering to the knowledge consumer generating the question with an associated purchase price, wherein the knowledge consumer may purchase and view the knowledge content in real time over the Internet.

In one embodiment, a computer-implemented interactive on-line knowledge content exchange system accessible via the Internet to a plurality of Knowledge buyers and Knowledge sellers is provided. The system includes: a host computer network having a web applications server providing a Web portal and a database accessible to the network that contains: an online knowledge content library browsable via remote computers through the Web portal and including a plurality of pre-qualified knowledge content packets that have met a set of quality metrics necessary for inclusion of the content packet in the library; and names of pre-qualified knowledge producers associated with each information packet that has met a set of credentialing criteria necessary to create and upload the information packets into the library. The system is operative such that a plurality of knowledge buyers may browse the online content library and purchase knowledge content packets from the library for viewing at a price established by each knowledge producer for their respective content packet.

In one embodiment, an Internet-based on-demand virtual Knowledge Marketplace System for professionals implemented via a Web-based computer and communication network is provided. The system includes: a host computer network; a communications network linking a plurality of remote knowledge consumer Internet access devices to the host computer network; at least one database accessible to the host computer network and storing a plurality of pre-packaged knowledge content information packets browsable via the remote Internet access devices through a Web portal, the information packets being uploaded to the system by a plurality of knowledge producer, each information packet having an associated viewing price designated by the knowledge producer for allowing viewing of their respective information packet. The host computer network is operative to select at least some of the information packets, compare the selected information packets against a set of quality content criteria, and designate selected information packets meeting the criteria as qualified content.

In some possible embodiments without limitation, the on-demand Knowledge Marketplace System according to the present invention may include providing knowledge, training, and services in such professional services industries and fields as Information Technology and Systems (IT), Software, Engineering, Product Development, Research, Marketing, Bio Sciences and Bio IT, Legal, Medicine, Dentistry, Business, Finance, Business Management, Securities Trading, and others. Accordingly, the present invention is readily adaptable to exchanging any type or kind of specific knowledge, training, or services that may relate to technical and non-technical fields such as accounting, finance, information technology, engineering, software, legal, etc. to name a few non-limiting examples. In other embodiments, the present on-demand Knowledge Marketplace System may also provide information related to various trades where technicians may look to solve problems encountered on the job or improve/update skill sets, such as automotive repair, plumbing, carpentry/constructions, electrical, etc. Accordingly, the present invention is intended to provide on-demand access to a plurality of various fields of professional, trade, or other type information all retrievable through a single web-based platform interface to the Knowledge Consumer.

In one embodiment, the invention provides an Internet-based networked information or data management, distribution, and communication computer system for professional knowledge, training and services. The system preferably includes computer programs (software) or control logic implemented and running on one or more networked computer and/or server processors having access to one or more computer-readable storage media or databases. The computers and/or servers are interconnected to each other and users over the Internet via a communication system and links for receiving, cataloging, locating, retrieving, exchanging, and distributing data and information related to the professional services, knowledge and training. The computers, servers, and communication system preferably uses commercially-available equipment, systems, and communication protocols.

In some embodiments, as further described herein, portions of the Knowledge Marketplace System according to the present invention may advantageously utilize conventional “cloud computing” wherein at least some of the computer programs and/or data may reside in networked computers or servers remote from, but accessible to via the Internet, the System's web server that provides an interface between Knowledge Consumers and Knowledge Producers. In some embodiments, the remote computers or servers holding the data and software may be part of a third party computer/server network accessible via the Internet.

In some embodiments, neither Knowledge Consumers or Knowledge Producers need to download any special software onto their remote computers to use the Knowledge Marketplace System wherein which may function primarily as only Internet access devices providing access to the virtual knowledge marketplace.

In one possible embodiment, the preferred system and method may be used in relation to IT (information technology and systems) professional knowledge, training and services wherein the knowledge content includes information on IT. However, it will be appreciated by those skilled in the art that the system and method described herein have broad applicability to any type of professional or trade knowledge, training and services. Accordingly, the invention is expressly not limited in its applicability to IT applications alone.

In one embodiment, a Web-based online computer system for creating a virtual knowledge marketplace and providing professional knowledge, training and services includes: a Web Applications Server for receiving a user information request related to professional knowledge, training or services via the Internet; one or more servers interconnected to the Web Applications Server via a networked communication system and including a computer processor for executing control logic; a database accessible to the server and storing professional knowledge, training and/or service content contributed by a plurality of professional providers; wherein the control logic is operable to process the user information requests, retrieve selective content based on the information requested by the user, and distribute the selective content to the user via the Internet.

In one embodiment, a computer-implemented method for providing Web-based professional knowledge, training or services via the Internet includes: providing a Web-based computer and communication network including a plurality of interconnected servers having access to at least one database, the database including professional knowledge, training and service information; receiving a knowledge, training or service information request from a user via the Internet; retrieving knowledge, training or service information associated with the request from the database; and delivering the requested knowledge, training or service information to the user via the Internet. The Web-based computer and communication network preferably includes circuitry implementing programmable control logic that directs the network to perform the foregoing functions. The control logic may be implemented in hardware, firmware, software, or any combination thereof one or more computers and servers as a matter of design choice. The servers and computers of the Knowledge Marketplace System according to the present invention may be located in one location and/or distributed over many locations remote from each other with communications therebetween preferably being performed over the Internet. In one embodiment, cloud computing may be used.

In one embodiment, a computer-implemented method is provided to compare professional knowledge, training and service solutions from a plurality of professional providers. The control logic is operable to process the Knowledge Consumer or user's information requests, retrieve selective content based on the “comparative information” requested by the user, and distribute the selective content to the user via the Internet. In one possible embodiment, a computer-implemented method is provided to “Preview”, “Download” and/or “Try out” the different knowledge, training and services from a plurality of professional knowledge providers or producers before making a “purchase” or “buying” decision.

In one embodiment, a computer-implemented method is provided, to direct customer feedback and ratings on knowledge, training, and services, wherein the control logic is operable to process the user requests, update the ratings on selective content based on the “qualitative rating and feedback information” provided by the user and store it in the database. In another preferred embodiment related to the IT field, a computer-implemented method to allow professional Knowledge Producers or providers to create a “Productized view” of the service offering and sell it as “Productized Service Solutions” with defined attributes like “Definition”, “Presentation”, “Deployment Instructions”, “Source Code/Executables”, “Productized Cost” etc. to name a few non-limiting examples for the defined service or solution being offered. Advantageously, the invention thus provides a single unified Web-based platform and “virtual marketplace” for on-demand service delivery, knowledge and training which operates in an environment that provides on demand live and real-time feedback to the user. This connects global skill sets into one convenient online platform and creates an entirely new distribution channel for professional service delivery, knowledge and training within a virtual marketplace.

In one preferred embodiment, a computer-implemented financial reward system which may be referred to as “SpinRate™” is provided as further described herein, wherein the control logic is operable to calculate a variable reimbursement rate to providers of professional knowledge, training, and services that is dependent upon market demand and supply of Knowledge Consumers and Knowledge Producers in a given category of knowledge, training, and/or service. The invention thus advantageously provides the capability to capture the “knowledge market” volatility and dynamics in one embodiment akin to the stock market using SpinRate™, thereby establishing the foundation for trading knowledge, training, and service as commodity based on supply and demand.

### BRIEF DESCRIPTION OF THE DRAWINGS

The features of the preferred embodiments will be described with reference to the following drawings where like elements are labeled similarly, and in which:

FIG. 1 is a schematic diagram showing the general components of an on-demand virtual Knowledge Marketplace System according to the present invention;

FIG. 2 is a chart showing the management and flow of knowledge or information content through different functional aspects or modules of the Knowledge Marketplace System according to the present invention;

FIG. 3 is a flow chart showing one embodiment of steps taken by a Knowledge Consumer and responsive actions implemented by control logic running on the Knowledge Marketplace System for processing a knowledge/information search or browse request according to the present invention;

FIG. 4 is a flow chart showing one embodiment of steps taken by a Knowledge Producer and responsive actions implemented by control logic running on the Knowledge Marketplace System for responding to a knowledge/information search or browse request in FIG. 3;

FIG. 5 is a schematic diagram of system architecture of a networked computer and communication system and web portals in which the online Knowledge Marketplace System according to the present invention may be embodied and operate;

FIG. 6 shows one embodiment of a GUI display screen web page which may be home page for a Knowledge Consumer or Knowledge Producer;

FIG. 7 shows one embodiment of a GUI display screen web page wherein knowledge content search results are displayed in line fashion to a Knowledge Consumer;

FIG. 8 shows an alternative embodiment of a GUI display screen web page wherein knowledge content search results are optionally displayed in group fashion to a Knowledge Consumer;

FIG. 9 shows one embodiment of a GUI display screen web page presented to a Knowledge Producer showing details of a Knowledge Query from a Knowledge Consumer and related information;

FIG. 10 shows one embodiment of a GUI display screen web page presented to a Knowledge Consumer illustrating a Knowledge Query search results comparison feature according to the present invention;

FIG. 11 shows one embodiment of a GUI display screen web page which provides a Knowledge Query input screen for a Knowledge Consumer to ask and submit a question in the Knowledge Marketplace System;

FIG. 12 shows one embodiment of a GUI display screen web page which provides a knowledge or information content upload screen for a Knowledge Producer to submit content to the Knowledge Marketplace System;

FIG. 13 shows one embodiment of a GUI display screen web page presenting results from browsing for knowledge or information content using category tags;

FIG. 14 shows one embodiment of a GUI display screen web page presenting the details of a single knowledge or information content offering to a Knowledge Consumer including content ratings;

FIG. 15 is a diagram showing one possible embodiment of a system configuration for integrating external third-party knowledge content into the Knowledge Marketplace System using application programming interfaces (API);

FIG. 16 is a flow chart showing one embodiment of a quality system process for qualifying Knowledge Producers and knowledge content;

FIG. 17 shows exemplary charts representing the results of data compilations and calculations performed by the Knowledge Marketplace System for prorating financial proceeds distribution to Knowledge Producers from knowledge content subscriptions;

FIG. 18 shows an exemplary chart of SpinRate™ financial trend variance over time for a single category of knowledge or information content;

FIG. 19 shows the function components of one embodiment of a model view control (MVC) software architecture for the Knowledge Marketplace System according to the present invention;

FIG. 20 shows a exemplary transaction and control logic flow for a Knowledge Producer creating and uploading knowledge content to the Knowledge Marketplace System based on the MVC of FIG. 19;

FIG. 21 shows a exemplary transaction and control logic flow for a Knowledge Consumer submitting a Knowledge Query (i.e. question) to the Knowledge Marketplace System based on the MVC of FIG. 19;

FIG. 22 shows an exemplary typical transaction and control logic flow for a Knowledge Producer requesting financial SpinRate™ infatuation for a single knowledge content category subscription; and uploading knowledge content to the Knowledge Marketplace System based on the MVC of FIG. 19;

FIG. 23 shows one embodiment of a GUI display screen web page presented to a Knowledge Consumer indicating the status of responses to several knowledge queries (i.e. questions) uploaded to the Knowledge Marketplace System;

FIG. 24 shows one embodiment of a GUI display screen web page presented to a Knowledge Consumer providing a data input screen for recording knowledge content ratings; and

FIG. 25 shows one embodiment of a GUI display screen web page presented to a Knowledge Consumer for selecting and completing a knowledge content subscription purchase in the Knowledge Marketplace System.

All drawings are schematic and not drawn to scale.

### DETAILED DESCRIPTION OF PREFERRED EMBODIMENTS

The features and benefits of the invention are illustrated for convenience by reference to non-limiting preferred embodiments. Accordingly, the invention expressly should not be limited to such preferred embodiments illustrating some possible non-limiting combination of features that may exist alone or in other combinations of features; the scope of the invention being defined by the claims appended hereto.

It will be appreciated by one of ordinary skill in the art that “computer program” or “control logic” as the terms may be used herein, may be implemented in hardware, firmware, software, or any combination thereof, as a matter of design choice. The terms “Knowledge Producer” or “Provider” as used herein shall be defined as any independent person, company, or organization that provides professional information or knowledge services and/or professional training. In terms of the virtual Knowledge Marketplace System described herein, the Knowledge Producer is a “seller” in a transaction for vending knowledge/information. The terms “user,” “client, “seeker,” or “Knowledge Consumer” as used herein shall be collectively defined as an independent consumer of professional information or knowledge services and/or professional training such as a person, company, or organization. In terms of the virtual Knowledge Marketplace System described herein, the Knowledge Consumer is a “buyer” in a transaction for acquiring knowledge/information. The term “Web” as used herein shall refer to the World Wide Web. The term “online” as used herein shall refer to any transactions or communications conducted via the Web and Internet. The term “knowledge content” as used herein shall refer to any type of information or data in any or type of format (e.g. textual, graphic, auditory, etc.) created by a person, company, or organization that may be exchanged in the professional Knowledge Marketplace System described herein.

For convenience of description only, various aspects of the preferred embodiments of the invention and the Knowledge Marketplace System described herein may be referred to by the term “SPINACT™” which is a trademark of SPINACT, LLC. Use of this fictional term expressly does not limit the invention in any respect.

An on-demand virtual global Knowledge Marketplace System according to the present invention includes a networked Internet location or website that may be hosted on several interconnected servers connected to multiple database and other servers, as further described herein. The virtual knowledge marketplace provides professional Knowledge Consumers and producers/providers with a single platform for listing, searching, cataloging, training, marketing, scheduling, networking, knowledge, training, and offering services to the clients globally in real-time.

The Knowledge Marketplace System according to the present invention is an online commercial knowledge and information exchange that connects knowledge seekers with knowledge holders. The system provides a mechanism for the transfer of professional knowledge, whether general or specific, from widely dispersed sources or Knowledge Producers to widely dispersed users or Knowledge Consumers efficiently, rapidly, and inexpensively. The system empowers knowledge holders to find knowledge seekers who can benefit from their expertise on a given topic, no matter how narrow, and enables them to productize and monetize that expertise.

A computer-implemented and interactive system and related method for establishing a Web-based online virtual knowledge marketplace according to the present invention that provides on-demand professional knowledge, training, and services will now be described with reference to some preferred non-limiting embodiments. Although the preferred embodiments describe a virtual knowledge marketplace in the context of professional knowledge, training, and services, it is expressly contemplated that the system and method herein may be broadly applied and adapted to other types of knowledge, training, and services such as the traditionally recognized trade professions for example. Accordingly, the invention is not limited to professional type knowledge, training, and services alone.

System Architecture

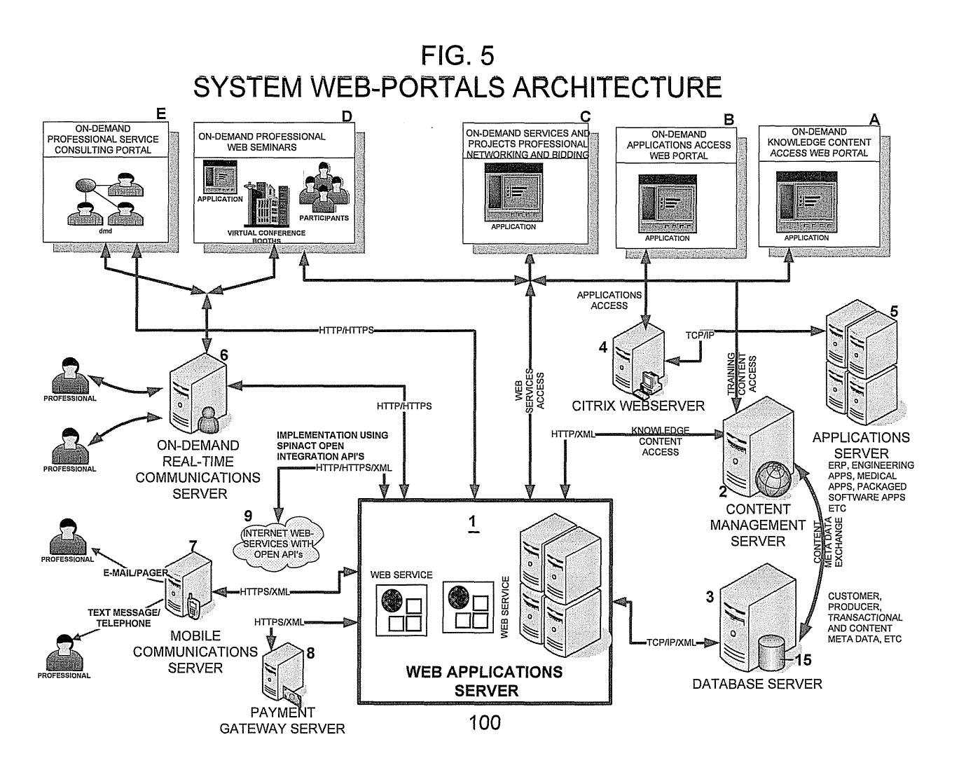

The basic system architecture for one embodiment of a virtual Knowledge Marketplace System 100 according to the present invention is shown in FIG. 5. The Knowledge Marketplace System 100 is a networked computer and communication system comprising a computerized data processing and communication network operative to exchange data via communication links. The Knowledge Marketplace System 100 preferably is built using commercially-available conventional components as described herein and which will be readily known to those skilled in the art. The Knowledge Marketplace System 100 includes software or computer programs running on one or more computers and/or servers all having on-board or remote computer-readable storage medium and communication links operable to exchange information between Knowledge Consumers, Knowledge Producers, and/or the System 100. In one embodiment, the Knowledge Marketplace System 100 generally includes a host computer network having a central computer or processor such as a Web Applications Server 1 which acts as a system hub that provides an Internet interface and access point or Web portal to the various components of the Knowledge Marketplace System for both Knowledge Consumers and Knowledge Producers over the World Wide Web. Web Applications Server 1 may be a conventional commercially-available server or networked group of servers including a central processing unit (CPU) or processor and ancillary on-board processors executing programmable control logic or computer programs (e.g. software) operative to control the processors and perform the functions described herein including controlling the operations/coordination of the server 1 with other networked components and remote user Internet access devices. Web Applications Server 1 further includes sufficient memory including RAM and ROM, clock drive, and accessible computer readable medium or data storage devices such as without limitation conventional magnetic (e.g. hard disk) or optical devices, etc. It is well within the ambit of those skilled in the art to determine sufficient processor speeds, memory, power supply, and other typical requirements needed for the Knowledge Marketplace System 100 described herein.

The Knowledge Marketplace System 100 includes a database management system (DBMS) comprising content management computer programs or software executing control logic operations and running on one or more database management servers/computers to organize the handling, storage and retrieval of data. In one possible embodiment, the content management software may be executed by a database management server such as Database Server 3 which is connected to Web Applications Server 1 via the host computer network. Database Server 3 may be one or more linked servers operative to access, store, organize, and retrieve data from accessible computer readable medium or data storage devices that include in combination one or more databases 15 accessible to the System via communication links (see FIG. 5). The Database Server 3 or servers may be located proximate to or remote from Web Applications Server 1 and databases 15.

In one embodiment, Database Server 3 running appropriately configured computer programs and control logic executed by the on-board processors are operative to perform conventional data management functions including for example without limitation archiving, sorting, filtering, searching, content searching within content, inline content editing, version management, tag (metadata) administration, etc. In some embodiments, another database management server such as Content Management Server 2 as shown in FIG. 5 may be provided that communicates via communications links and operatively cooperates with the Database Server 3 to perform some or all of the conventional data management type functions. In some system architecture configurations, Content Management Server 2 may be used to augment the Database Server 3 if, for example, the amount of data stored and processed by the Knowledge Marketplace System becomes too large for the Database Server alone to manage. It will be appreciated, however, that in other embodiments a Database Server 3 or Content Management Server 2 alone may be used so long as the necessary database and content management software functions and control logic may be performed. Content Management Server 2 may be proximate or remote to Database Server 3 and accessible via communication links such as the Internet.

In one embodiment, the Database Server 3, Content Management Server 2 if deployed, and associated databases 15 may be part of an external online third-party network remote from Web Applications Server 1 with access thereto being provided via a communication network and links over the Internet. Accordingly, in some embodiments, conventional “cloud computing” may be employed wherein the Database Server 3 and/or Content Management Server 2 containing content management software and databases holding the data/information used by the Knowledge Marketplace System (e.g. knowledge content) actually resides remotely from Web Applications Server 1, and in some embodiment maybe part of third-party networks.

In one embodiment, as shown in FIG. 5, Web Applications Server 1 may provide a Knowledge Consumer or Knowledge Producer with a variety of possible access portals to the Knowledge Marketplace System 100; each portal being dedicated to a specific functional aspect of the system as further explained herein. Communication links between Web Applications Server 1 and other components of the system such as Database Server 3, applications server 5, etc. may be accomplished via conventional wireless or hard wired network communication interconnections. These other system components and access portals shown in FIG. 5 will be further described herein with the description of the various functional aspects performed by these other components.

A Knowledge Consumer or Knowledge Producer user may access Web Applications Server 1 via any Internet access-capable device including without limitation conventional remote personal computers, cellular phones, personal digital assistant (PDA) or Blackberry type devices, etc. Communications between these Internet access devices and Web Applications Server 1 may be performed via any suitable conventional hard-wired (e.g. high-speed cable, DMS, optical fiber, telephone modem, etc.) or wireless technologies (e.g. microwave, satellite network, etc.).

Knowledge Marketplace System Description and Operation

The preferred embodiments described herein provide an on-demand virtual professional marketplace accessible via the Internet which is intended to serve without limitation at least three professional Knowledge Consumer needs in a more expedient and efficient manner than heretofore possible. In one embodiment, as further described below, these three needs are fulfilled by a Knowledge Marketplace System that provides a professional Knowledge Consumer with access to: (1) on-demand professional knowledge; (2) on-demand professional training; and (3) on-demand pre-packaged standard professional service solutions.

The latter on-demand professional service solutions component is enabled by productizing standard type service offerings in terms of providing pre-packaged “solutions” on a particular topic each having a specific defined scope and “Service Attributes.” These “Service Attributes” may define the minimum set of deliverables expected by a Knowledge Consumer out of a “Productized Service Solution” in a given “Knowledge Category.” For example, in an Information Technology based Productized Service Solution in one embodiment, the requisite service attributes might be for example “Definition,” “Presentation/Working Demo”, “Software Deployment Instructions,” “Source Code/Executables,” “Productized Cost,” etc. to name a few. In one simplistic example, a “Productized Service Solution” may include providing the Knowledge Consumer with an in-depth answer containing required equipment and step-by-step instructions for setting up an office LAN (local area network). Thus such Productized Service Solutions contain information to address the type of technical or other issues commonly encountered by many business or organization who are in need of the same professional solution thereby not requiring expensive customized solutions. As used herein, the term “solution” shall be used to refer to such pre-packaged Productized Service Solutions which are accessible to Knowledge Consumers through the online virtual Knowledge Marketplace System described herein.

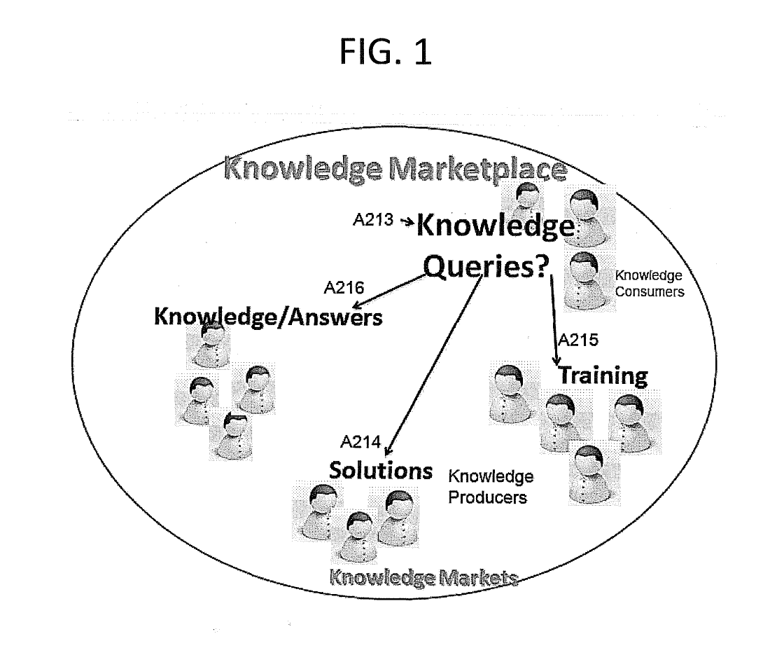

The functional components of a global Internet-based Knowledge Marketplace System according to one embodiment of the present invention are broadly depicted in FIG. 1. Referring to FIG. 1, the on-demand Knowledge Marketplace System may comprise three complementary functional data or knowledge centers, each center being associated with a segment or portion of a structured database accessible to the Knowledge Marketplace System and which centers contain a particular content type or class of knowledge or infoiniation (e.g. classification) stored in a computer readable medium as further described herein. The three knowledge centers in one embodiment includes:

(1) “Knowledge Center” A216;

(2) “Training Center” A215; and

(3) “Solutions Center” A214.

The Knowledge Marketplace System in one embodiment, therefore, is preferably adapted and operative to receive knowledge content from Knowledge Producers over the Internet in the form of pre-packaged professional information packets, assign Knowledge Producer-identified or System-designated tags (metadata) to each packet according to content type, and sort and organize the knowledge content or packets into at least two or more content classifications or types of information and knowledge. Preferably, at least two different knowledge content types are provided. In one preferred embodiment, these content types may be professional service solutions (Solutions Center A214 type packets), professional short answers (Knowledge Center A216 type packets), and professional training (Training Center A215 type packets). The Knowledge Marketplace Sytem is further operative to store the tagged knowledge content or information packets in system accessible databases, enable searches and queries by Knowledge Consumers for the information packets, and retrieve information packets on demand based on retrieve requests input into the Knowledge Marketplace System by Knowledge Consumers. This knowledge content organization is intended to provide the Knowledge Consumer with more choices over the type of information displayed and retrieved by the present system in lieu of the “one size fits all” approach of existing online information systems to offering online information to Knowledge Consumers. This advantageously will allow Knowledge Consumers to access exactly the type of knowledge content they are seeking more quickly than existing online bulk information storage and retrieval systems. Preferably, the type and/or level of detail of information or knowledge provided by each of the foregoing three Centers to the Knowledge Consumer is different, as further described below.

In one preferred embodiment, the knowledge content or information packets created by Knowledge Producers and handled by the Knowledge Marketplace System contains professional information related to IT. In other possible embodiments, information related to other professional or trade areas as identified herein and others may be contained in the information packets. Accordingly, the knowledge content of the information packets is not limited to any particular profession or trade.

The Knowledge Center A216 provides “Knowledge” content or information of a type which may be classified and described as short task or project specific responses or answers (i.e. information) with a low level of detail relevant to a specific search or query A213 input into the Knowledge Marketplace System by the Knowledge Consumer. The Knowledge Center A216 therefore provides quick “know-how” knowledge or “short answers” to the professional Knowledge Consumer to allow them to resolve a specific problem at hand that very limited in scope and not require much detailed information. The Knowledge Consumer can determine whether this type of answer would satisfy their information needs depending on the nature of the question or search query.

The Solutions Center A214 provides standardized “Solutions” content or information of a type which may be classified and described as a professional service solution knowledge content or information packets that provide a comparatively lengthier and more in-depth detailed response to the Knowledge Consumer having a greater or higher level of detail than the Knowledge Center A214 on a particular topic. Accordingly, the volume of information contained in a service solution information packet is greater than the “short answer” information packets associated with a Knowledge Category (Knowledge Center A214). Solution Center A214 preferably contains the “Productized Service Solutions” already described above and offers detailed pre-packaged standard service solutions (e.g. step-by-step instructions) on a particular topic having a topic-specific defined scope and “Service Attributes.”

The Training Center A215 provides “Training” content or information of a type which may be classified and described as traditional online training courses or offerings of a more generalized character leading to a broad-based understanding of the technology or subject matter being searched in the Knowledge Consumer's query. Accordingly, a response of this nature is not intended to and may not specifically address a particular issue or problem being investigated by the Knowledge Consumer. The Knowledge Consumer, in such instances, may be a Knowledge Producer looking for training to acquire or update a set of skills on a particular topic or subject area. Generally speaking, the Training Center Training knowledge content or information packet provides a comparatively lengthier and more in-depth information to the Knowledge Consumer with a greater or higher level of detail than either the Knowledge or Service Solutions Categories of knowledge content or information packets on a particular topic. Accordingly, the volume of information generally contained in a Training knowledge content or information packet is greater than the Knowledge or Service Solutions Categories as well.

In some embodiments, as further described herein, the Knowledge Marketplace System may function as a Web portal seamlessly and transparently linking the Knowledge Consumer with content pre-existing in searchable databases accessible via the Internet including online training modules offered by existing Internet-based training organizations such as Lynda™, etc. Accordingly, the Knowledge Marketplace System in some embodiments may function as a communication network linking the Knowledge Consumer to the knowledge training producer without requiring that the entire training modules be already uploaded onto the Knowledge Marketplace System's databases. In other embodiments, at least some training modules or courses may be uploaded onto the Knowledge Marketplace System's databases and available directly to the Knowledge Consumer.

The Knowledge, Solutions, and Training Centers A216, A214, and A215 respectively advantageously provide Knowledge Consumers with complementary choices regarding the type and level of detail of the information and/or training options available. This allows the Knowledge Consumer, not the Knowledge Producer or provider, to select the desired and appropriate type and/or level of information detail needed commensurate with the Knowledge Consumer's specific needs at hand. Such flexibility and choices offered by the Knowledge Marketplace System according to the present invention have generally heretofore not been provided in a single integrated Web-accessible platform offering the Knowledge Consumer the choice of all types of information available (i.e. Knowledge, Solutions, and Training Centers).

Knowledge Consumers of professional information and/or services can access the Knowledge Marketplace System online and on-demand at any time of day from anywhere in the world (i.e. wherever an Internet connection is available) to quickly get the desired professional knowledge, training, and solutions directly from Knowledge Producers without going through the heretofore “in between players” that merely add to costs while contributing little or nothing of substance or value to the Knowledge Consumer. The present invention therefore advantageously provides a more efficient and cost-effective system of directly linking clients to knowledge, training and service providers.

The foregoing Knowledge, Solutions, and Training Centers of the Knowledge Marketplace System according to the present invention will now be further described.

Knowledge Center

The Knowledge Center A216 enables the exchange of information on narrow, specific topics. Knowledge Consumer professionals with questions related to a particular task or challenge can post queries, and other Knowledge Producer professionals can post and display responses to the Knowledge Consumer using the multimedia tools described herein. In one embodiment, the system is operative to also store, organize, and categorize responses by topic or subject matter via conventional data tagging methodologies on a database accessible to the system's networked servers. The Knowledge Marketplace System further is operative to automatically retrieve relevant stored responses related to the Knowledge Consumer's specific query, and post/display the past relevant stored responses to the Knowledge Consumer. In one embodiment, the system further provides Knowledge Producers with financial compensation for their posted information packet if selected and purchased by the Knowledge Consumer, as further described herein in relation to “SpinRate™.”

Training Center

The Training Center A215 offers preexisting professional training modules on various topics, which may be broad or specialized in nature. A training module may be standalone, like an individual class session, or part of a series, like an entire training course. The Training Center content can be submitted by any type of professional or expert, including a professional training company, an academic institution, an e-learning company, an enterprise application software provider, or an independent consultant. In one embodiment, the training modules may be uploaded into the Knowledge Marketplace Systems networked servers and store in a database accessible thereto for retrieval by Knowledge Consumers. As further described herein, in some embodiments the Knowledge Marketplace System may in addition also function as a portal to a Knowledge Consumer for accessing training modules that reside on servers operated by existing online training providers such as Lynda, but which are networked to the present system via a communication link like the Internet and accessible to users of the Knowledge Marketplace System via a conventional application programming interface. The training module content may feature any combination of audio, video, text, graphics, and animation.

Solution Center

The Solution Center A214 enables organizations to source comprehensive professional services solutions among a broad range of experts. Users submit queries that include detailed project requirements, and consultants respond with specific proposals. Solution Center™ provides relevant communications, scheduling, content creation, and other tools. As some solutions may have broad applicability, they may be made available, with the permission of the consultant and client, to general SPINACT™ subscribers.

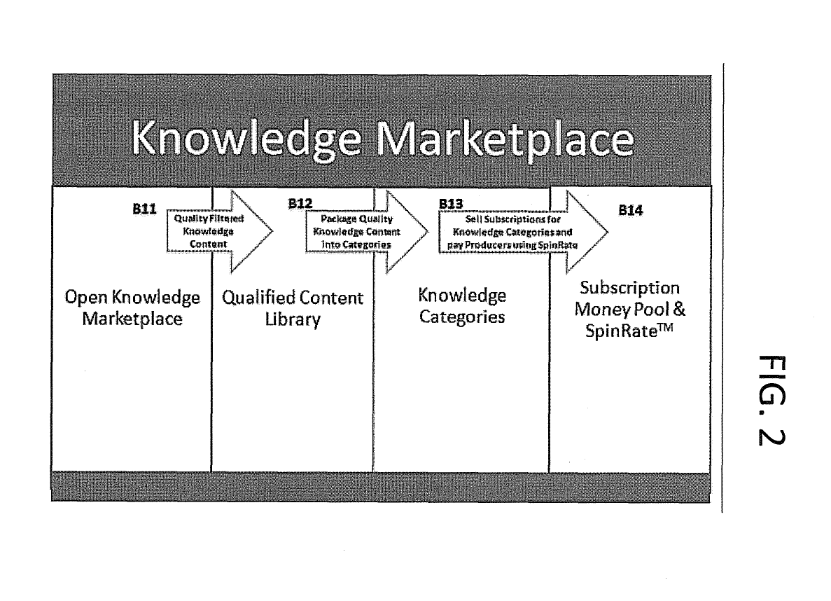

The SPINACT™ Knowledge Marketplace System will operate as an open system, inviting both the Knowledge Consumers and Knowledge Producers to post information queries and information responses (i.e. knowledge content) respectively. The knowledge content, however, preferably has an associated purchase or viewing price, which is paid by the Knowledge Consumer in order to view the content. FIG. 2 generally shows the flow of information or knowledge content through a Knowledge Marketplace System according to the present invention. There are four unique aspects of the SPINACT™ Knowledge Marketplace System. These are illustrated in FIG. 2 as: Open Knowledge Marketplace (B11); Qualified Content Library (B12); Knowledge Categories (B13), which may be pre-packaged into user-subscribable topical Category Buckets in some embodiments as further explained herein; and Subscription Money Pool and SpinRate™ (B14). These features and preferred embodiments will now be discussed in detail below.

Open Knowledge Marketplace (Step B11, FIG. 2)

Knowledge Consumer Process Flow

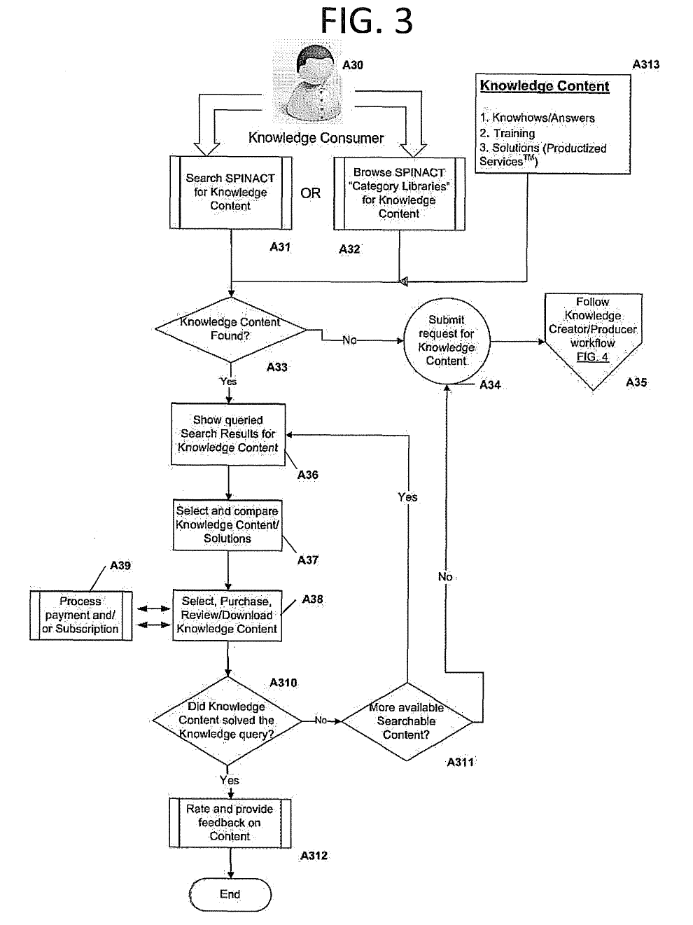

The process of a Knowledge Consumer A30 using the Open Knowledge Marketplace B11 aspect of the SPINACT™ Knowledge Marketplace System (shown in FIG. 2) will now be described with initial reference to FIG. 3. FIG. 3 shows a flow diagram or chart of steps taken by the Knowledge Consumer A30 and associated operations performed by the Knowledge Marketplace System 100 executing instructions or control logic programmed into and running on the System's computer and communication network (see FIG. 5) that is responsive to input and selections made by the Knowledge Consumer. The primary portions of the network implementing the Knowledge Marketplace B11 includes a Web Applications Server 1, Database Server 3 and/or Content Management Server 2.

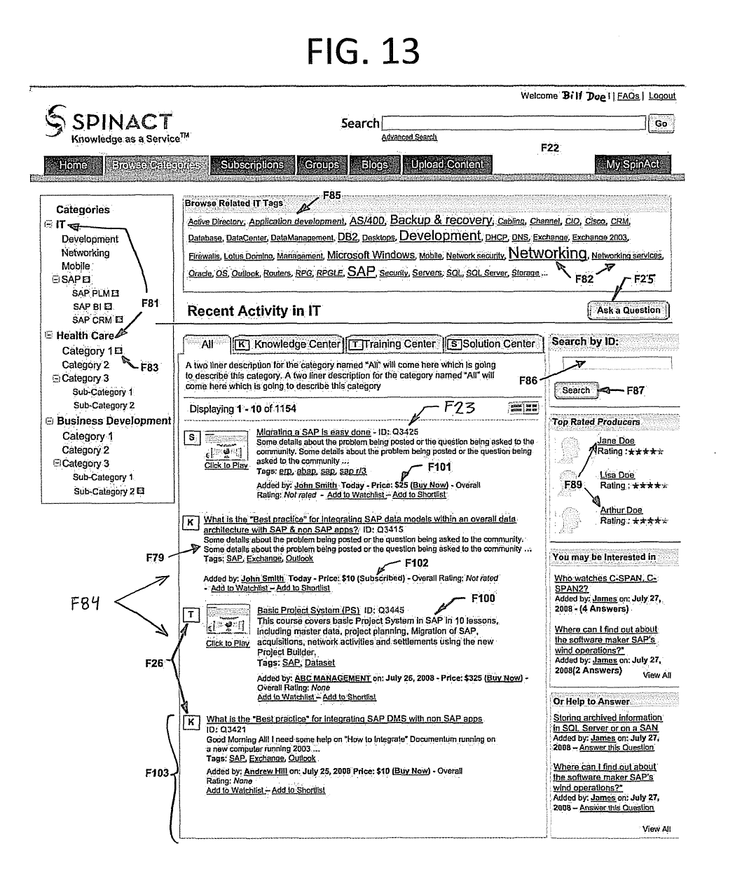

Referring to FIGS. 3, 5, and 13, the Knowledge Consumer A30 uses their remote computer or other Internet access device to initially gain access the Knowledge Marketplace System 100 via the Internet through On-Demand knowledge content Access Web Portal A (shown in FIG. 5), which is hosted on Web Applications Server 1 interconnected to the Database Server 3 and its associated databases 15. The Knowledge Marketplace System 100 receives an access request from the Knowledge Consumer, implements instructions related to the request, and in return presents the consumer with a graphical user interface (GUI) on their video display device (VDD) screen, such as the display screen shown in FIG. 13 which can be viewed by the Knowledge Consumer using the browser on their Internet access device. The Knowledge Marketplace System 100 invites the Knowledge Consumer A30 to either post a knowledge or information search query (Step A31) or alternatively to search for pre-existing knowledge content F103 (Step A32) already posted by Knowledge Providers and resident in the Knowledge Marketplace System's Qualified Content Library databases 15 as described below.

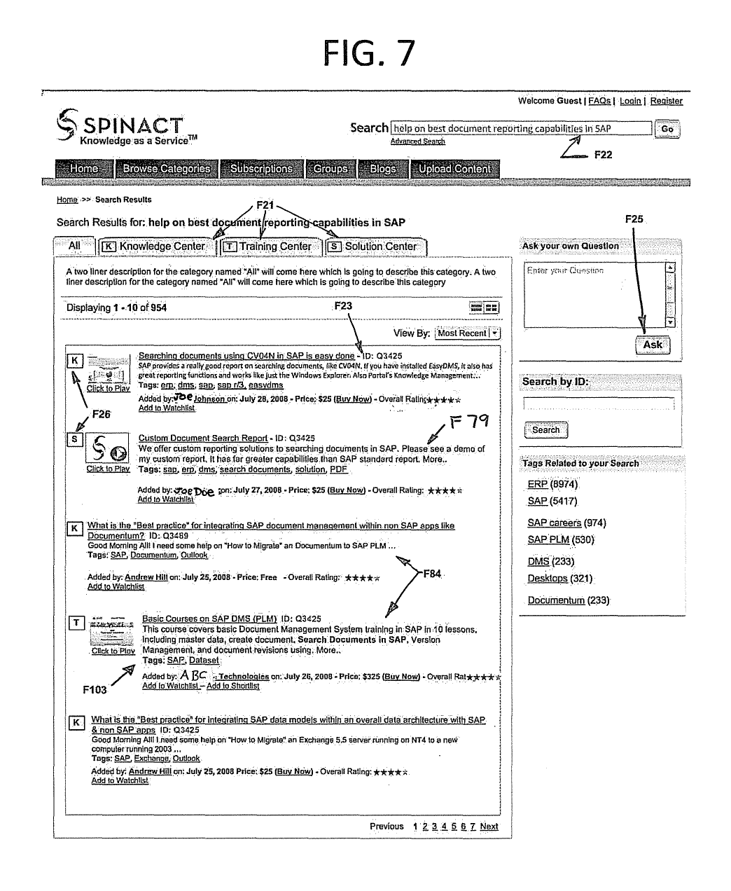

As noted above, the Knowledge Consumer A30 may conduct searches for pre-existing knowledge content F103 (Step A31) by typing his or her search query into the “SPINACT™ Search Engine” search field F22 shown in FIGS. 7 and 13 and clicking the “Go” button in a conventional manner. Alternatively, referring to FIG. 13, the Knowledge Consumer can browse for pre-existing knowledge content F103 (Step A32) which may reside in the Knowledge Marketplace System's databases 15 (FIG. 5) and Qualified Content Library by selecting one of the pre-defined topical Knowledge Categories F81 tags appearing in the webpage display screen. It should be noted that these topical Knowledge Categories F81 relate to professional technical, business, or other professional topics or subject matter (e.g. IT, Health Care, Business Development, etc. as shown) and are distinct from knowledge content type classifications (e.g. Knowledge, Training, and Solution Centers content types shown) which are assigned to describe and organize the information packets submitted by Knowledge Producers according to content type. Accordingly, each topical category F81 may contain a plurality of professional content information packets of different content types (e.g. Knowledge, Solutions, Training, etc.).

With continuing reference to FIG. 13, alternatively, the Knowledge Consumer may browse for knowledge content by selecting one of a plurality of tags F82 displayed in the “Intelligent Tag Cloud” F85. Tags F82 are used during the creation of “Knowledge Queries” and “knowledge content F103” as metadata for both and enables the Knowledge Marketplace System's Semantic intelligence search network as further described herein. In one embodiment, the Knowledge Marketplace System 100 may be operative and programmed with control logic that displays prominent tags F82 in Intelligent Tag Cloud F85 in a hierarchical order such as of different increasing font sizes and/or different colors based on any number of factors such as the number of searches conducted in that tag category by Knowledge Consumers (i.e. high traffic or popularity) and others.

The relationship between a topical Knowledge Category F81 (e.g. IT, Health Care, Business Development, etc.) and dynamic tags F82 in Tag Cloud F85 is depicted in FIG. 13. Preferably, tags F82 are context sensitive and are generated in response to the knowledge category F81 selected by the Knowledge Consumer A30. For example, as shown in the particular scenario illustrated in FIG. 13, the Tag Cloud F85 displays tags F82 to the Knowledge Consumer A30 that are relevant to and in response to the Knowledge Category F81 “IT” which has been selected by the Knowledge Consumer. Tag Cloud F85 is controlled by the Knowledge Marketplace System 100 to refresh the displayed tags F82 on a continuously changing basis as the user clicks on different Knowledge Categories F81 and Knowledge Sub-Categories F83. The user can alternatively further narrow his/her search by clicking on a specific tag F82 within the Tag Cloud F85. The Tag Cloud F85 advantageously facilitates and accelerates the speed at which a Knowledge Consumer A30 can navigate through the Knowledge Marketplace System 100 to obtain the relevant information desired.

Referring to FIG. 5, when the Knowledge Consumer in Portal A either clicks on a category or tag in Step A32, FIG. 3 or alternatively enters a search request query and clicks “Go” (see FIG. 13) in Step A31, FIG. 3, the knowledge content request is received by Web Applications Server 1, which in turn generates and passes a select query to Database Server 3 with instructions to retrieve search results F84 associated with pre-packaged information packets residing in the System databases 15 that are responsive to knowledge content request. In some embodiments, a Content Management Server 2 may be used in addition or instead of Database Server 3.

Referring now again to FIG. 3, if the Knowledge Marketplace System 100 (specifically Database Server 3 in one embodiment) finds knowledge content F103 (FIG. 13) in its databases 15 that is relevant to the search query or browse request entered into the system by Knowledge Consumer A30 (i.e. control logic returns a “yes” response in Step A33), the Database Server 3 retrieves and passes the search/query results F84 (see FIG. 7 or 13) back to the Web Applications Server 1 in Step A313. Web Applications Server 1 in turn posts the results in XML format back to Web Portal A, refreshing the portal view for the Knowledge Consumer with results F84 of his/her query or search in a display screen such as the one embodiment shown in FIG. 7 (Step A36, FIG. 3). Preferably, the search results returned are only a representative portion of the entire knowledge content F103 (i.e. pre-packaged information packets), and more preferably in the form of abstracts or summaries (also referred to herein as “Previews” or snapshots) that are prepared by a Knowledge Producer when creating new knowledge content for uploading into the Knowledge Marketplace System. In order to view the full version of the infoiniation packet or knowledge content F103, the Knowledge Consumer must purchase viewing rights to the knowledge content.

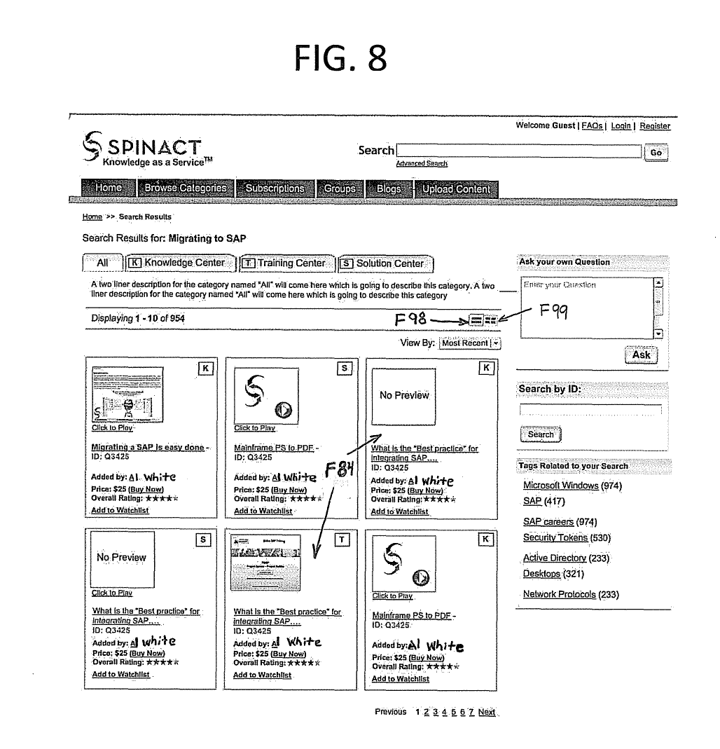

Referring to FIGS. 3 and 7, in a preferred embodiment, the Knowledge Marketplace System 100 is operative to retrieve, organize, and display the search results F84 (i.e. information packets) to the Knowledge Consumer in an organized manner that will facilitate quick viewing and selection of the most relevant knowledge content F103. In one embodiment, the search results F84 are organized and displayed according to the type of knowledge content F103 or information. For example, as shown in FIG. 3, the search results F84 in one embodiment may be organized and displayed in Step A36 according to knowledge content F103 type which in a preferred embodiment includes at least three content types such as: Knowledge Center (“KnowHows” or short answers); Training Center (“SpinCourses™” or training courses); and Solution Center (“SpinSolutions™” or Productized Service Solutions) as already described herein. An identifier such as a graphical icon F26 of any style or type may be assigned by the Knowledge Marketplace System to each knowledge content F103 and displayed in the Knowledge Consumer's Web portal display screen to quickly identify into which Knowledge Center A214, A215, or A216 each response falls into. Accordingly, each Knowledge Center is preferably associated with knowledge content F103 or information of these specific types or categories as already described herein. In other embodiments, the Knowledge Marketplace System 100 may organize, retrieve, and display knowledge content F103 in categories and Knowledge Centers other than those specifically enumerated herein. Accordingly, the present invention is not limited to the foregoing three Knowledge Centers or categories of information which are representative of only one possible embodiment of the Knowledge Marketplace System.

Whereas FIG. 7 displays the search results F84 grouped in lines by the Knowledge Consumer selecting/clicking the line display button F98, FIG. 8 shows an alternative display option wherein search results are displayed in group fashion by the Knowledge Consumer selecting/clicking the group display button F99. Other suitable display options and grouping of search results may be used.

Alternatively, referring again to FIG. 3, if the Knowledge Consumer browses pre-existing knowledge content F103 in the system 100 by navigating through the pre-defined Knowledge Categories F81 or by selecting the dynamic tags F82 displayed in the “Intelligent Tag Cloud” F85, the Knowledge Marketplace System 100 may retrieve and generate the knowledge content F103 results in a display screen as shown in FIG. 13 (Step A36). The knowledge content F103 search result are displayed in a similar organized/categorized way according to the three Knowledge Centers similarly to results generated from query searches shown in FIG. 7 and described above.

In Step A37 in FIG. 3, the Knowledge Consumer A30 may next select, view, and compare various individual search results F84 (FIGS. 7 and 13). As shown in FIGS. 7 and 13, a content type folder tab or tag F21 may be displayed in some embodiments which can be selected by the Knowledge Consumer according to the content classification or type of professional information or knowledge content F103 that each particular search result F84 falls into, such as Knowledge Center type responses, Training Center type responses, or Solution Center type responses. Selecting one of the content type tabs F21 will display only the results falling into the Knowledge Center selected. In the embodiment shown, an “All” content type tab may be provided which combines and displays responses from all three content types and Knowledge Centers. This feature of the present knowledge marketplace advantageously allows the Knowledge Consumer A30 to sort through the responses more quickly and quickly focus only those kind of responses that satisfy their “just in time” information needs to address the specific issue at hand.

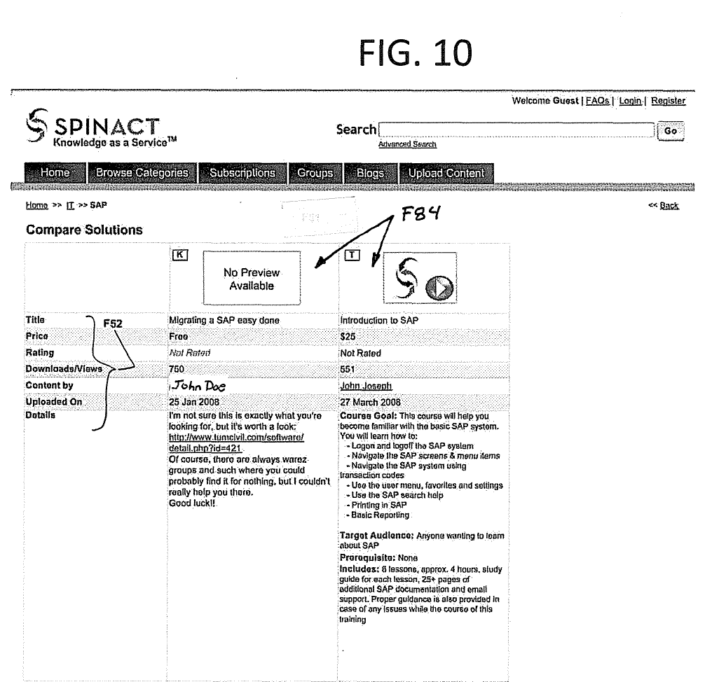

With continuing reference to FIGS. 3 and 8, the system 100 may be further operative to allow the Knowledge Consumer to select multiple individual knowledge content F103 offerings from a plurality of Knowledge Producers and compare the same side-by-side (Step A37, FIG. 3). FIG. 10 shows one possible embodiment of a graphic display screen generated by the Knowledge Marketplace System and displayed to the Knowledge Consumer illustrating the search results comparison feature of the present invention. The display screen displays a plurality of search results F84 selected for comparison by the Knowledge Consumer and shows many different “Knowledge Attributes” F52 of interest displayed in fields such as Title, Price, Ratings, Number of Views/Downloads, Knowledge Producer's Profile, Preview details, etc. as some non-limiting examples. This side-by-side comparison and Knowledge Attributes F52 allows the Knowledge Consumer to select the most relevant knowledge content F103 from the search results F84 (FIGS. 7 and 13). Alternatively, the Knowledge Consumer may wish to search each search result individually by simply selecting (i.e. clicking) each one and reviewing the content abstract or summary.

Preferably, as noted above, the descriptions provided in the search results F84 (see, e.g., FIGS. 7, 10, and 13) are only abstracts or summaries of the knowledge content F103 (pre-packaged information packet) contained in each potential selection. In order to view the entire detailed knowledge content F103 of interest, the Knowledge Consumer must purchase the content. The Knowledge Marketplace System displays a “Pay-Per-View” price F101 allowing the Knowledge Consumer to view the knowledge content on a basis as shown in FIG. 13. Each knowledge content F103 may have the same or different prices F101 than others.

In Step A38 shown in FIG. 3, the Knowledge Consumer next selects, purchases, and reviews/downloads the desired knowledge content F103 selection from the search results F84 which is initiated by clicking on “Buy Now” tag for Open Knowledge Marketplace content or the “Subscribed” tag for content from the Qualified Content Library (see for example FIGS. 7 and 13). The Knowledge Consumer's knowledge content selection request is received by Web Applications Server 1 which in turn generates and sends instructions to Database Server 3 (and/or Content Management Server 2 in some embodiments) to retrieve the full or complete knowledge content from databases 15 associated with the Unique ID (see, e.g. FIG. 13, item F23) assigned to the selected knowledge content. The selected knowledge content is retrieved by Database Server 3 and/or Content Management Server 2, which in turn sends and downloads the content into the Knowledge Consumer's remote Internet access computer or other device, and displays the knowledge content in a Webpage via cached data through Web Applications Server 1 and Web Portal A.

In one embodiment, the Knowledge Consumer has the option to purchase and view the selected knowledge content F103 either (1) at the “Pay-Per-View” price (individual piecemeal purchase of single knowledge content F103 selection), or (2) through a “subscription” covering a pre-defined collection of more than one knowledge content F103 offering in a particular knowledge content F103 technical/business area referred to herein as topical “Category Bucket.” As will be further described herein, these Category Buckets F83 shown in FIG. 13 may include the types of content residing in the Knowledge Center A216, Solutions Center A214, and/or Training Center A215 as already described herein and shown in FIG. 1. The subscription option provides the Knowledge Consumer with the ability to view all knowledge content F103 residing with a given technical/business area Category Bucket F83 in a certain Knowledge Center.

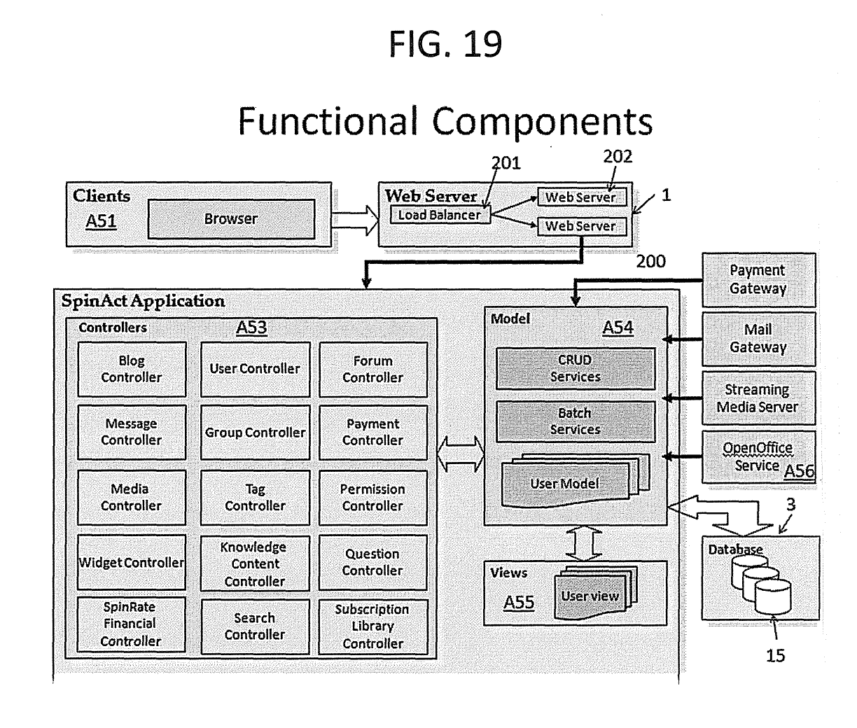

The Knowledge Marketplace System will automatically collect, manage, track and update on a continuous basis a list of active Category Bucket subscriptions associating each Knowledge Consumers and Knowledge Producers via their unique ID with the Category Buckets in which they hold valid descriptions. This subscription information may reside in a dedicated subscriptions database residing in databases 15 whose contents are managed and controlled by Subscription Library Controller 200 shown in FIG. 19. When search results F84 (see FIGS. 7 and 13) are generated by the Knowledge Marketplace System, the System will automatically access and verify in its subscriptions database whether the Knowledge Consumer holds a valid subscription to the Category Bucket containing the particular knowledge content F103 of interest. If so, the Knowledge Marketplace System will allow access to that particular knowledge content F103 when the Knowledge Consumer selects the content for viewing without any further payment. In some embodiments, the Knowledge Marketplace System preferably provides visual notification to the Knowledge Consumer of a valid subscription on a knowledge content-by-knowledge content basis by displaying a subscription icon or indicia F102 (in this example, the word “Subscribed”) along side each displayed knowledge content in the search results F84 that is covered by the Knowledge Consumer's existing Category Bucket subscriptions. The Knowledge Marketplace System may further be operative to identify each Knowledge Consumer's or Knowledge Producer's active subscriptions by displaying an icon or indicia along side each subscribed Category Bucket F83 as shown in FIG. 13.

Alternatively, in some embodiments, the Knowledge Marketplace System is operative to offer the Knowledge Consumer at this point in the purchase transaction the option of purchasing a subscription to the entire particular Category Bucket containing the selected knowledge content F103 if not an existing subscriber to that Category Bucket. The Knowledge Marketplace System then prompts the Knowledge Consumer for payment information for any conventional commercially-accepted online payment methods (e.g. PayPal™, Amex™, etc.), and processes the Category Bucket subscription purchase transaction as shown in Step A39, FIG. 3. The Knowledge Marketplace System 100, via particularly the Payment Gateway Computer/Server 8 (see FIG. 5), communicates and connects the Knowledge Marketplace System to external online payment systems to receive authorization for the Knowledge Consumer's payment and completing the payment transaction in a usual manner. The Knowledge Marketplace System then authorizes access to the Knowledge Consumer for the knowledge content F103 selected. This same foregoing payment process (Step A39, FIG. 3) may be used by the Knowledge Marketplace System for processing payments and opening access to the selected knowledge content F103 when viewing rights are purchased on a piecemeal Pay-Per-View. For the Pay-Per-View option, as well as for subscription purchases, the system 100 is therefore preferably operative to allow the Knowledge Consumer to complete the purchase transaction using conventional accepted methods of online payments in real time preferably at any time of the day from any place worldwide where Internet access is available.

Referring again to FIG. 3, if the Knowledge Consumer's query and issue is solved by reviewing the purchased or subscribed knowledge content F103 (Step A310), he/she proceeds to rate and provide feedback on the knowledge content F103 (Step A312). Advantageously, the “SPINACT™ Rating and Feedback System” serves as one form of quality control mechanism for knowledge seekers to gauge the quality of Professional Knowledge, Training or Service Solutions. This will assist other would-be purchaser's of the same knowledge content F103 to make a better informed decision before purchase and gain a relative feel for the quality and reliability of the information that will be obtained specific to any particular knowledge content F103 and/or Knowledge Producer. Such a quality control mechanism has heretofore been generally lacking in conventional online information formats.

Referring to Step A310 in FIG. 3, if alternatively the Knowledge Consumer's query and issue are not completely solved by the selected knowledge content F103 from the search results, Step A311 may be performed in which the Knowledge Consumer is presented with two options. First, if there are other search results F84 (see e.g. FIG. 7) not selected from the previous query which are of interest (“Yes” in Step A311), the Knowledge Consumer may select a different knowledge content F103 from the list in Step A36 again and purchase/review that selection in Step A38 again. If the Knowledge Consumer does not find any more searchable knowledge content F103 for the query of potential interest from the query search results F84, or if the system 100 finds no search results F84 based on the search query (“No” in Step A311), the Knowledge Consumer can submit an on-demand request for “knowledge content F103” (Step A34, FIG. 3) by clicking the “Ask a Question” button F25 shown in FIGS. 7 and 13.

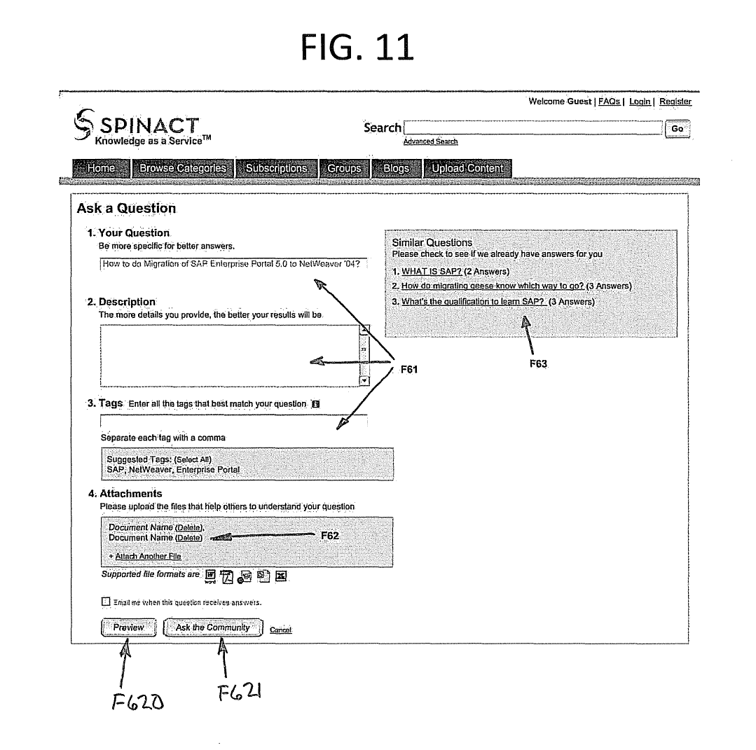

Clicking the “Ask a Question button F25 generates and displays the graphic display screen shown in FIG. 11, which further illustrates the process steps for requesting on-demand knowledge content F103. The “Ask a Question” input screen includes data entry fields F61 which allows the Knowledge Consumer to enter his/her question and categorize the question with tags. The Knowledge Consumer types in a question in the “Your Question” field, optionally adds a further description of the question or problem in the “Description” field to assist Knowledge Producers with addressing the problem, and enters relevant tags which categorize the subject matter of the question. In one embodiment, the Knowledge Marketplace System 100 generates suggested tags via Semantic Intelligence based on words entered into the Your Question and Description fields by the Knowledge Consumer. Preferably, the Knowledge Marketplace System 100 is enabled with Semantic searching and word linking technology. The “Ask a Question” request as depicted in FIG. 11 illustrates the preferred system's “Semantic Intelligence,” in terms of automatically finding/displaying relevant tags in the Tag field based on the Knowledge Consumer's question and finding other similar questions asked previously by the “Knowledge Marketplace” community. The system then automatically generates and displays “Similar Questions” to the Knowledge Consumer in display field F63 for consideration as the question is being input and typed. This advantageously reduces errors and duplication of metadata and allows for a self-organizing “Knowledge Marketplace” to evolve through expanding and continuous usage of the system.

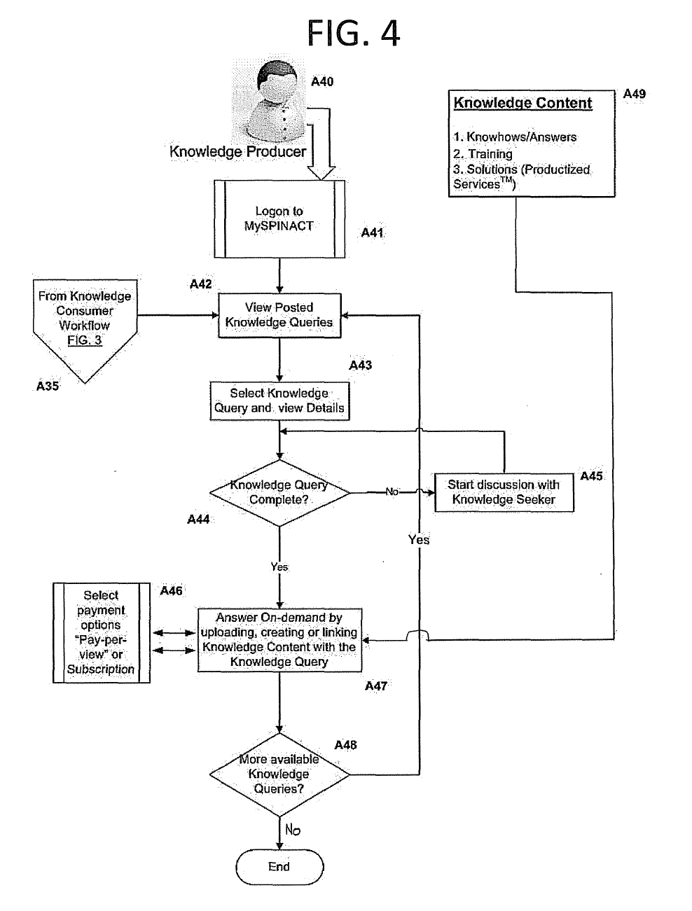

As shown in FIG. 11, the system 100 is further operative to allow the Knowledge Consumer to attach Supporting Data files F62 such as “Screen shot of System Errors”, “Requirement Document”, “Video Recording of a Product Specifications”, etc. as a few of the many non limiting examples to further help the Knowledge Provider in creating responsive on-demand knowledge content F103 to answer the question. The system is adapted and operative to support many of the industry standard document, video, audio, and other executable supporting data file formats. The user may click the “Preview” button F620 to review the question request for knowledge content F103, and then clicks the “Ask the Community” or similar button F621 to submit the question to the Knowledge Marketplace Community. The system 100 then publishes the Knowledge Consumer's question in the Knowledge Marketplace which is automatically routed to Knowledge Producers for consideration as shown in Step A35, FIGS. 3 and 4.

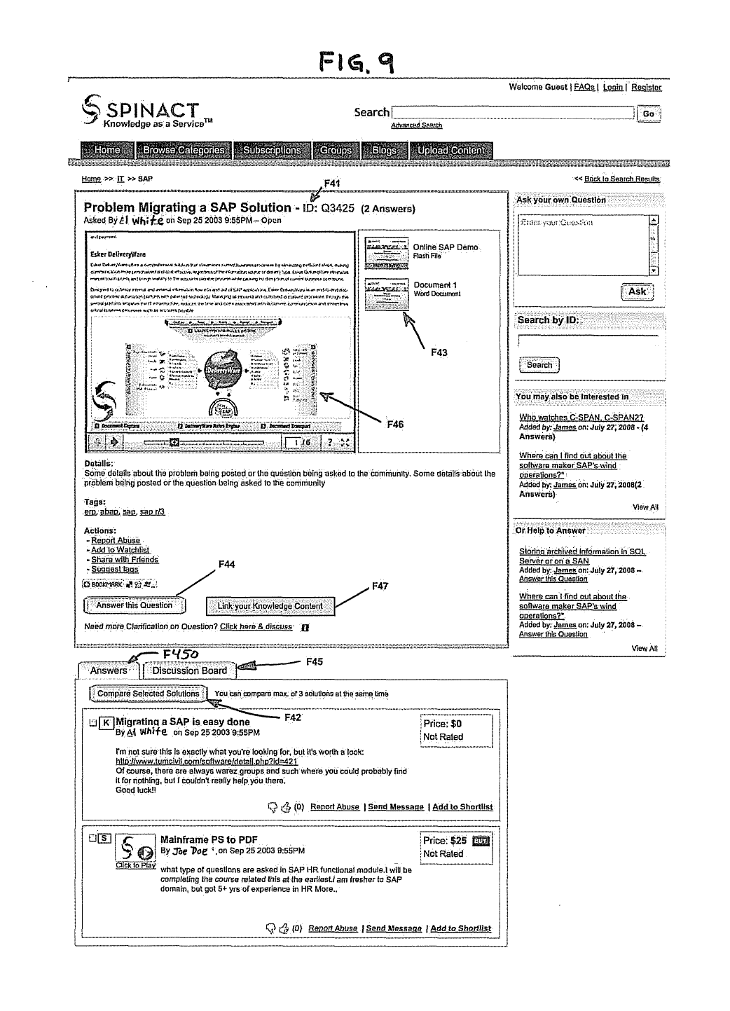

According to another aspect of the present invention, with reference to the display screen shown in FIG. 13, a returning Knowledge Consumer has the option of retrieving and reviewing search results from previous queries or searches. The Knowledge Marketplace System 100 automatically assigns a unique ID (Database Key) to both every Knowledge Query (i.e. “Ask a Question”) (see, e.g. F41, FIG. 9) from a Knowledge Consumer and every knowledge content F103 uploaded or linked by the Knowledge Producers (see, e.g., F23, FIG. 7). This unique ID allows the Knowledge Marketplace System to store, track, and retrieve Knowledge Query and knowledge content F103 data from the system's databases 15. As shown in FIG. 13, the Knowledge Marketplace System 100 allows searching and linking of both Knowledge Queries and knowledge content F103 by this unique ID through entering the ID in a provided ID Input Field F86 and clicking on the ID Search Button F87. The system 100 operates to then retrieve and display the ID-related knowledge content F103 or Knowledge Query to the Knowledge Consumer or Knowledge Producer on their Internet access device.

According to another aspect of the present invention, with continuing reference to FIG. 13, the Knowledge Marketplace System 100 may further provide a query display field F88 showing the Knowledge Consumer A30 queries previously posted by other Knowledge Consumers that are relevant to the query input by the present Knowledge Consumer. In many cases, the present knowledge Consumer A30 may have relevant answers to other Knowledge Consumers' past queries. The query display field invites the present Knowledge Consumer to respond. Because in some instances the present Knowledge Consumer may be Knowledge Producer as well, this provides new opportunities for the present Knowledge Consumer-Producer to expand their business and use of the SPINACT™ Knowledge Marketplace System.

Knowledge Producer Process Flow

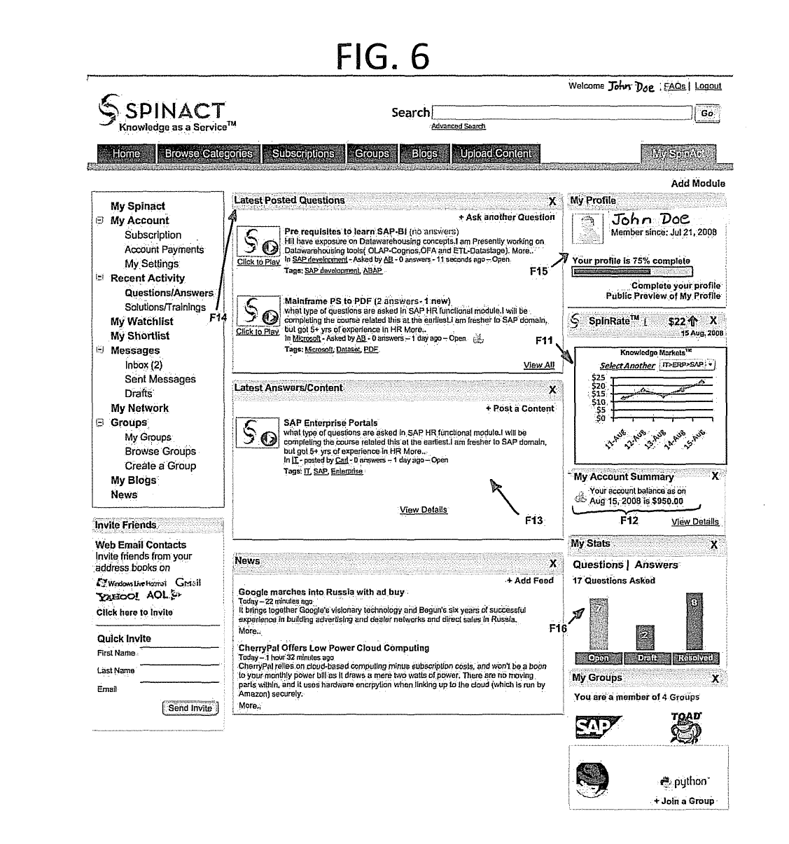

FIG. 4 shows a flow diagram or chart of steps taken by the Knowledge Producer A40 and associated operations performed by the Knowledge Marketplace System 100 using control logic programmed into and running on the system's computer and communication network that is responsive to input and selections made by the Knowledge Producer. In Step A41, the Knowledge Producer A40 uses their remote computer or other Internet access device to log onto the SPINACT™ Knowledge Marketplace System 100 through On-Demand knowledge content F103 Access Web Portal A (shown in FIG. 5) hosted on Web Applications Server 1, which is interconnected to the Database Server 3 (and/or Content Management Server 2 in some embodiments) and its associated databases 15. Preferably, the Knowledge Marketplace System 100 requires that all Knowledge Producers be pre-registered online and have created an account with the system before being allowed to participate as a Knowledge Producer. Accordingly, in some embodiments, the Knowledge Marketplace System would require the user to enter a previously created and registered user name and password associated with their account in a conventional manner. The Knowledge Marketplace System 100, upon receiving the access request from the Knowledge Producer and confirming that the Knowledge Producer is registered and permitted to participate as a Producer, generates/presents the Knowledge Producer with a “MySPINACT™” display screen shown in FIG. 6. This display screen is a portal that defines a “Virtual Workplace” for the Knowledge Producer providing a variety of information that facilitates the use of and navigation through the Knowledge Marketplace System 100. Accordingly, FIG. 6 shows one possible embodiment of a Knowledge Producer “home page.”

In one embodiment, FIG. 6 may also be the same MySPINACT™ homepage that is displayed to a registered Knowledge Consumer (i.e. one who has established an account with the SPINACT™ Knowledge Marketplace System). An account is required for a Knowledge Consumer to purchase knowledge content or subscribe to a Category Bucket as further described herein. However, in some embodiments a Knowledge Consumer may submit a Knowledge Query (question) and conduct searches and browse for knowledge content without first establishing an account by logging into the Knowledge Marketplace System as a guest or anonymously. An account would be required, however, to purchase content or a subscription.

The MySPINACT™ display screen shown in FIG. 6 may include fields such as “My Profile” F15 which may include a photo or other details about the Knowledge Producer, and which may be an active link to profile data input form (not shown) allowing the Knowledge Producer to add a new or edit an existing profile. In one embodiment, the Knowledge Marketplace System 100 may be operative to access and retrieve existing user profile information already existing in the world wide web on various networking websites such as LinkedIn™, etc. Accordingly, the Knowledge Producer would be presented by the system 100 with an option of using an existing profile and requested to input or select the website (e.g. from a drop-down list) where the profile resides. The system 100 then accesses and downloads the Knowledge Producer's existing profile and allows the content to be edited and saved to the Knowledge Marketplace System's databases 15. In other possible embodiments, the Producer input display screen shown in FIG. 6 may include a “My Stats” field showing such information as the Knowledge Producer's activities.

With continuing reference to FIGS. 4 and 6, the Knowledge Producer A40 may view the posted “Knowledge Queries” or questions by Knowledge Consumers in Step A42 (FIG. 4) which are displayed in the Latest Posted Questions field F14 shown in FIG. 6. Field F14 is populated with recent posted Knowledge Queries from Step A35 shown in FIGS. 3 and 4 as described above. The Latest Answers/Content F13 to posted questions may be displayed to the Knowledge Producer in the display screen In Step A43 (FIG. 4), the Knowledge Producer selects a Knowledge Query and views its details which are presented by the system 100 in the display screen shown in FIG. 9. The Knowledge Query and all the supporting files (F43, FIG. 9) uploaded by the Knowledge Consumer are now displayed in a display screen by the “SPINACT™ Player”, a video and text output device (F46, FIG. 9). The Knowledge Marketplace System is preferably built to support both textual and audio/video content. The Knowledge Producer may also view all answers to the Knowledge Query already posted by other Knowledge Producers by clicking the Compare Selected Solutions Button F42 under the “Answers” Tab F450 in FIG. 9. In Step A44, the Knowledge Producer determines if the query and supporting files are complete enough to provide an answer to the Knowledge Producer's question. If the answer is “No” in Step A44 wherein the Knowledge Producer requires further information about the query (Step A44, FIG. 4) from the Knowledge Consumer to answer the posted query/question, the Knowledge Producer can start a discussion (Step A45) with the Knowledge Consumer by selecting the “Discussion Board” tab F45 depicted in FIG. 9. The Knowledge Producer may then request additional details on the problem or issue in an input field that is generated by the Knowledge Marketplace System. The system is operative to transmit the request entered into the discussion board to the Knowledge Consumer that originally made the knowledge request.

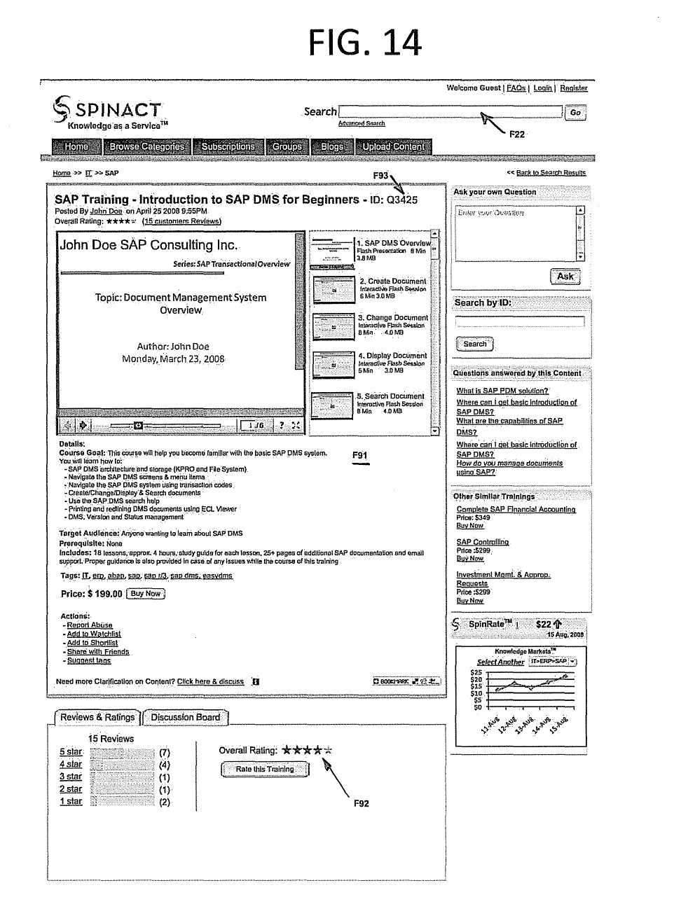

If the answer is “Yes” in Step A44 wherein the Knowledge Producer has sufficient information from the Knowledge Producer to answer the query/question, the Knowledge Producer can answer the query on-demand (Step A47, FIG. 4) by either (1) creating and uploading new knowledge content F103 via clicking the “Answer this Question” button F44 (see FIG. 9), or alternatively (2) linking the Knowledge Query to an already uploaded knowledge content F103 via clicking the “Link your Content” Button F47 (see FIG. 9). If the latter, selecting the Link your Content Button F47 in some embodiments may cause the present System to generate a list of the Knowledge Producer's already created knowledge content F103 resident in the Knowledge Marketplace System's database 15 by the unique ID (metadata tags) automatically assigned by the System as already described above. The Knowledge Producer may then select one or several of their pre-existing knowledge content F103s from the list and send the ID links to this content through the Knowledge Marketplace System to the Knowledge Consumer that generated the original Knowledge Query. The present System will retrieve and display the existing linked knowledge content in the Knowledge Consumer's webpage the same as other newly created Knowledge Consumer with the preview, Knowledge Producer name, and other relevant information as shown for example in FIG. 14.

If the Knowledge Producer does not have any relevant existing knowledge content F103 to address the Knowledge Query at hand in Step A47 of FIG. 4, the Knowledge Producer may optionally create new knowledge content F103 for uploading to the Knowledge Marketplace System as described below. The process for creating new knowledge content F103 for uploading onto the Knowledge Marketplace System is essentially the same regardless of whether the new knowledge content F103 is prepared in response to an existing Knowledge Query or not.

The Knowledge Producer generates and uploads new knowledge content F103 to the Knowledge Marketplace System 100 as follows. First, the Knowledge Producer creates the new knowledge content F103 using their preferred software tools. The knowledge content F103 may be either Knowledge Center, Solutions Center, or Training Center type content. Advantageously, the Knowledge Marketplace System 100 is operative to support a variety of multimedia content creation and presentation tools. This gives the Knowledge Producer the ability to create, upload, tag, and package a variety of knowledge content F103, supporting many of the industry standard software and file formats: Word™, Excel™, Screen Recordings™, PowerPoint™, PDF, video, audio, Flash, Open Office, Webinar recordings (e.g. Yugma™, WebEx™), and many others. In one embodiment, for example, the Knowledge Marketplace System 100 includes and runs conversion engine software that preferably converts all industry standard formats to Adobe Flash™ for viewing on the System. The Knowledge Marketplace System 100 is therefore preferably operative to support the presentation of various different formats in a common Flash format, allowing Knowledge Producers with disparate knowledge content creation software/tools to create/publish content in many different formats, while Knowledge Consumers may access and view knowledge content in a single simple interface provided by the Knowledge Marketplace System 100. In one embodiment, the Knowledge Marketplace System 100 further is operative to support “inline commenting”—Knowledge Consumers can post comments and queries on a specific scene (video), slide (e.g. PowerPoint), or page of a document in order to interact and clarify content from Knowledge Producers.

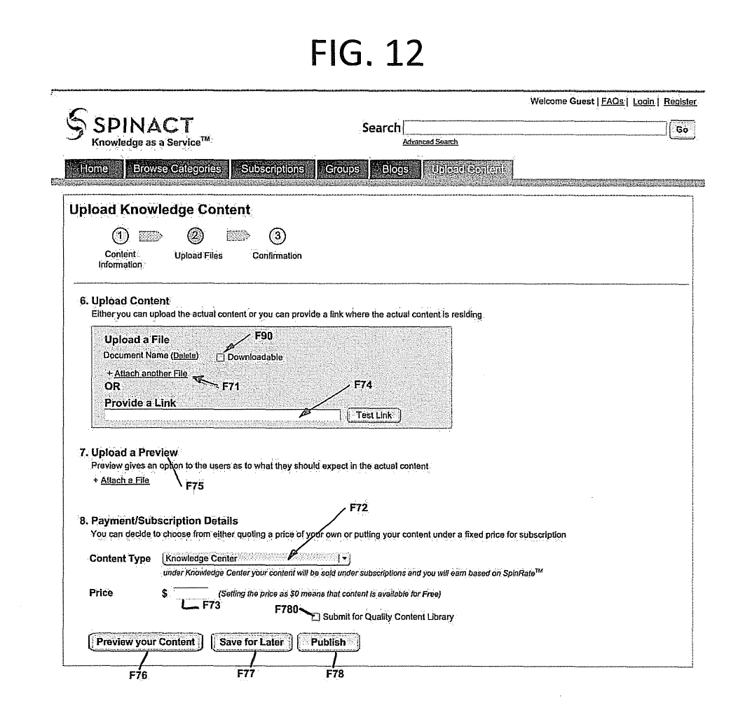

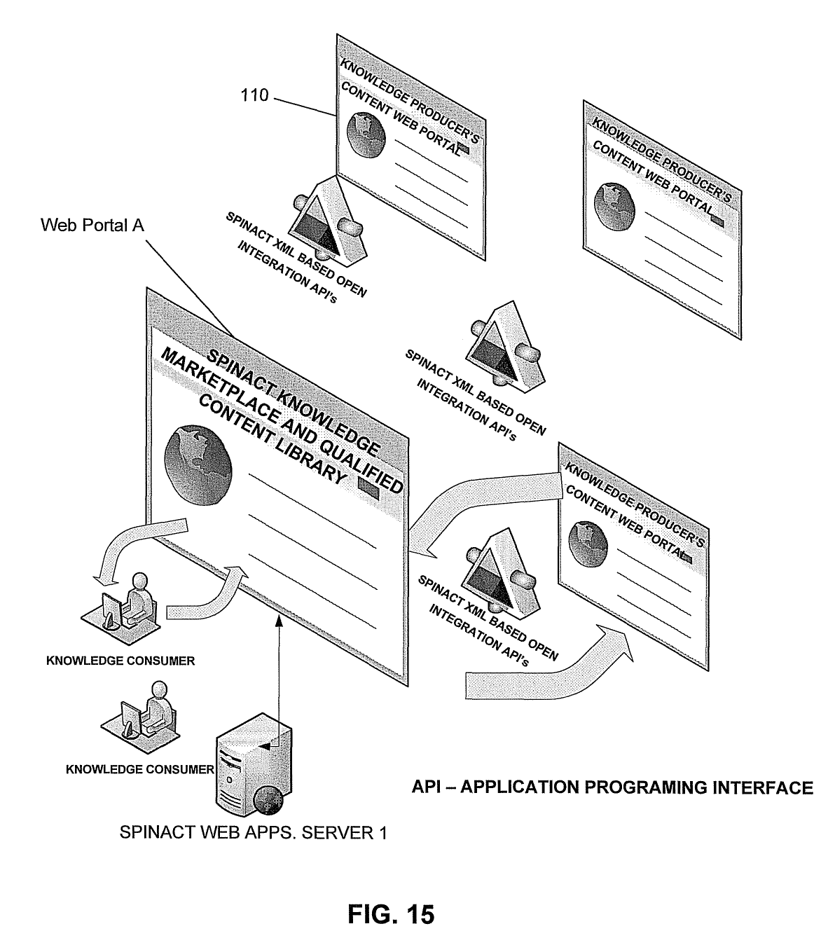

After the Knowledge Producer creates the new knowledge content F103 which may be in the form of one or more textual, graphic, and/or voice data files, the new content files may then be uploaded into the Knowledge Marketplace System 100. FIG. 12 shows a Knowledge Producer display screen generated by the Knowledge Marketplace System for uploading new knowledge content F103. The System 100 generates this display screen in response to the Knowledge Producer clicking on the “Upload Content” tab shown in FIG. 12. Referring to FIG. 12, the Knowledge Producer uses the “Attach Another File” Link F71 to upload one or more Knowledge Consumer files. The files already in the queue for uploading are listed in the “Upload a File” field. The Knowledge Producer may grant permission for Knowledge Consumers to download some or all of the attached knowledge content F103 files to their own computers or Internet access device by marking the “Downloadable” Box F90. This allows the Knowledge Consumer to save the knowledge content F103 to their machines in lieu of only having the ability to view the knowledge content F103 on the Knowledge Marketplace System. In some embodiments, the system also allows the integration to knowledge content hosted on other Web sites by either allowing the Knowledge Producer to link it using the URL (entered into URL field F74 shown in FIG. 12) or by using SPINACT™ Open Integration API's (Application Programming Interfaces) as illustrated in FIG. 15 which is further described elsewhere herein. In some embodiment, the Knowledge Marketplace System may be operative to allow the Knowledge Producer to test the URL link by clicking a “Test Link” button shown.

Next, after all desired new knowledge content F103 files are in the queue for uploading to the Knowledge Marketplace System, the Knowledge Producer preferably has created a written abstract or short summary of the Content, referred to herein also as a “Preview,” which provides Knowledge Consumers with an overview of what the particular knowledge content F103 covers. This allows the Knowledge Consumer to determine if the knowledge content F103 will serve their needs ultimately leading to a purchase decision. The Knowledge Marketplace System is operative to display a Preview F79 for each knowledge content F103 to the Knowledge Consumer in a display screen as shown in FIGS. 7 and 13 for example (see Item F79). Accordingly, the “Upload a Preview” F75 feature shown in FIG. 12 allows the Knowledge Producer to select the “Attach a File” link and ultimately upload the Preview F79 into the Knowledge Marketplace System. The Knowledge Marketplace System is operative to associate the Preview with the particular knowledge content F103 files being uploaded into the System.

Next, with continuing reference to FIG. 12, the Knowledge Producer proceeds to input an appropriate knowledge content classification or type as already described herein, which in one embodiment may be selected from a content type drop-down list F72. In one embodiment without limitation, the available content types displayed to the Knowledge Producer may include the content types associated with the Knowledge Center A216, Solutions Center A214, and Training Center A215 (see FIG. 1) as already described in detail herein. It will be appreciated that other embodiments of the present invention may include additional and/or different categories of knowledge content F103. The Knowledge Marketplace System will interpret and/or assign tags (metadata) to the uploaded knowledge content information packet based on the content type designated by Knowledge Producer during the upload process. It will be appreciated that the Knowledge Marketplace System may be operative to confirm that the appropriate content type designation has been identified by the Knowledge Producer, and may be further operative to change the content type if incorrect. Personnel responsible for monitoring, maintaining, and operating the Knowledge Marketplace System may be involved in verifying and changing the content type as required.

Referring to FIGS. 4 and 12, the Knowledge Producer next determines a price that will be charged to a Knowledge Consumer for purchasing the rights to view the knowledge content F103 created in Step A46 shown in FIG. 4. This may or may not include download capabilities as previously described if the Downloadable Box F90 is marked. The Knowledge Producer sets by the price by entering the desired dollar value in the “Price” Box F73 shown in FIG. 12. In one embodiment, if “$0” is entered for the dollar value in Box F73, the Knowledge Marketplace System will indicate that the Knowledge Consumer may be viewed for free at no cost to any interested Knowledge Consumer. In some instances, the particular type of knowledge content F103 category such as Knowledge Center may be subject to subscription pricing for an entire “Category Bucket” as further described herein with reference to subscription pricing.

With continuing reference to FIG. 12, the Knowledge Marketplace System is operative to allow the Knowledge Producer to perform a final review of the Knowledge Consumer to be uploaded into the System by clicking the “Preview your Content” Button F76. Referring also to Step A47 in FIG. 4, the Knowledge Producer may then either decide to: (1) save the Preview F79 and associated knowledge content F103 files in the Knowledge Marketplace System as a draft for uploading at a later time by clicking the “Save for Later” Button F77; or (2) upload the new knowledge content F103 immediately by clicking the “Publish” Button F78 or similar. As shown in Step A48 in the process flow of FIG. 4, the Knowledge Producer may then either “End” their review of posted Knowledge Queries if no additional Knowledge Queries are posted (“No”) or return to Step A42 to review/respond to other posted Knowledge Queries (“Yes”).

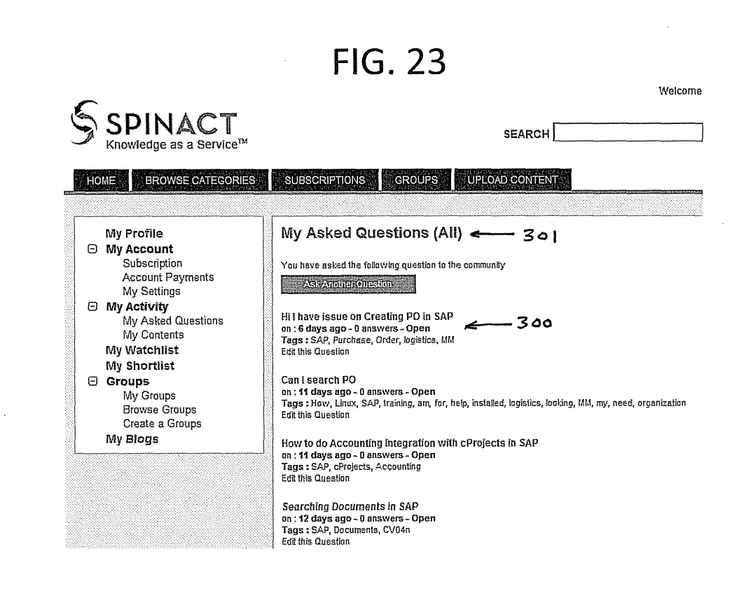

The Knowledge Marketplace System is operative to post the new knowledge content F103 answers back to the Knowledge Consumer. In one embodiment, the Knowledge Marketplace System may generate an email to the Knowledge Consumer originating the Knowledge Query (“Ask a Question”) alerting the Knowledge Consumer that a corresponding response has been generated and posted by a Knowledge Producer. The email may be sent to Knowledge Consumer and posted under their MySPINACT™ web page or display screen (see FIG. 23) and/or sent to the Knowledge Consumer's personal email. In the Knowledge Consumer's MySPINACT™ display screen shown in FIG. 23, the “My Asked Questions” tab 301 will open a list of submitted Knowledge Queries 300 and indicate whether any responses have been received to specific questions/queries. Clicking on one of the listed questions/queries will open a new web page or display screen listing all response to that particular question/query.

Qualified Content Library (Step B12, FIG. 2)

According to another aspect of the present invention, the knowledge content or information exchanged and stored and/or managed in SPINACT™ Knowledge Marketplace may be filtered from the Open Knowledge Marketplace B11 into a SPINACT™ Qualified Content Library B12 as shown in FIG. 2. Knowledge content or information packets that are part of the Qualified Content Library B12 have undergone and passed a quality metrics review (i.e. the “filtering”) as further described herein. This “Qualified Content” is intended to provide the necessary indicia of information reliability demanded by Knowledge Consumers in businesses to manage risk in making decisions and changes to the status quo which may have adverse financial impacts if the information is not accurate. The lack of this indicia of information or data reliability makes existing open knowledge exchange Websites unsuitable for obtaining and exchanging professional knowledge.

The Qualified Content Library B12 (see FIG. 2) which has topics relevant to different professional categories. According to one embodiment, professionals can contribute information or knowledge content which will be considered for inclusion into the online Qualified Content Library, and which can be accessed by other professional Knowledge Consumers seeking knowledge content. This professionally relevant Qualified Content Library would make it a seamless process for the Knowledge Consumer to browse (see, e.g. FIG. 13 showing browsable Library knowledge content), purchase, view, and/or download this knowledge content without the need for additional hardware or pre-installed software running on their own machines, thereby basically creating a unique platform for knowledge transfer. Preferably, professionals will be evaluated on this knowledge content and their profiles in the Knowledge Marketplace System will be updated in a common database. The knowledge content filtration into the Qualified Content Library is achieved by the implementation of SPINACT™ Quality System as described below.

In one embodiment, the Qualified Content Library B12 (FIG. 2) preferably includes at least two types of knowledge content including standardized professional “service solutions” type knowledge content (Solutions Center A214, FIG. 1) and professional training type knowledge content (Training Center A215, FIG. 1) as already described herein. In a preferred embodiment, short answer “knowledge” type content (Knowledge Center A216, FIG. 1) is not included in the Qualified Content Library because these short answers or “know-hows” exchanged in the Open Knowledge Marketplace B11 (FIG. 2) are generally casual in nature and not of the type warranting quality review. Knowledge Producers in business will typically demand some indicia of quality or information reliability when it comes to longer more formal type knowledge exchange such as Knowledge Consumers seeking productized professional standard service solutions and professional training. In other possible embodiments, however, short answer “knowledge” type content may also be included in the Qualified Content Library.

It should be noted that in a preferred embodiment, all three content types described herein (i.e. professional short answer knowledge, standardized service solutions, and training) may be purchased and exchanged in the Open Knowledge Marketplace B11 (FIGS. 1 and 2) of the present Knowledge Marketplace System. The Qualified Content Library is contemplated to represent a smaller selective portion of all of the knowledge content exchanged in the Open Knowledge Marketplace comprising primarily service solutions and training type content.

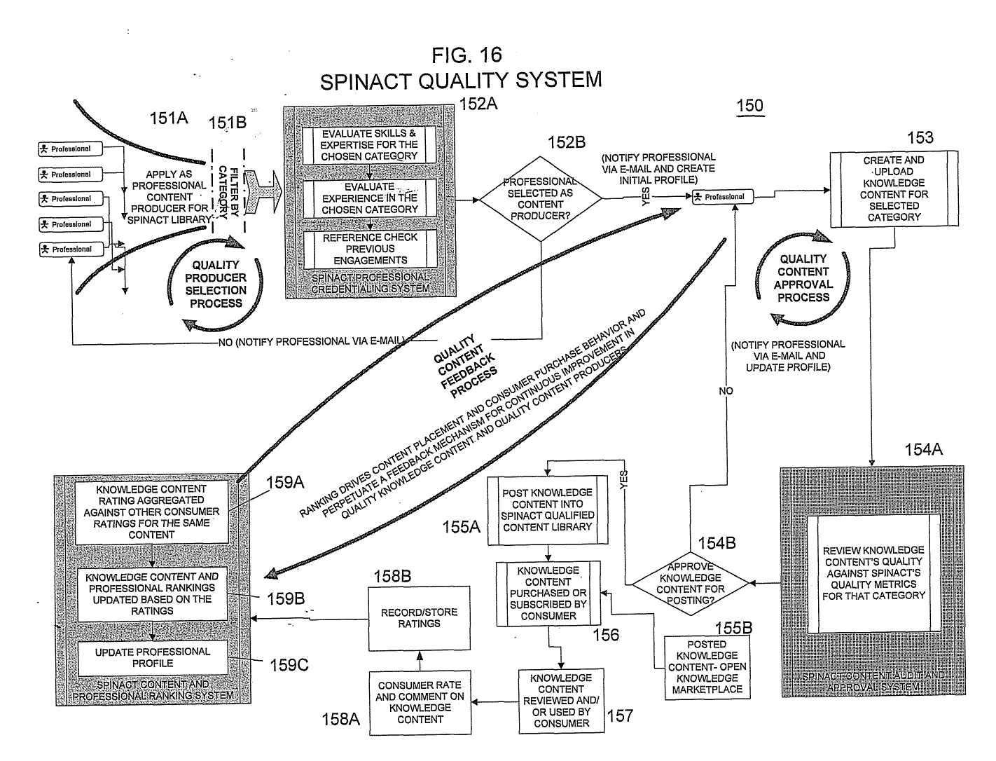

FIG. 16 shows the process flow 150 of the SPINACT™ Quality System which may be used for both qualifying Knowledge Producers to contribute knowledge content to the Qualified Content Library and/or for this knowledge content to be incorporated into the Qualified Content Library. In one embodiment, the first part of the SPINACT™ Quality System is the quality Knowledge Producer selection process. Step 151A in this figure illustrates Knowledge Producer candidates who create knowledge content applying to and registering in the Knowledge Marketplace System 100 through Web-Portal A (FIG. 5) communicating with Web Applications Server 1. These Knowledge Producers are filtered (Step 151B) by the Knowledge Marketplace System into their pre-selected respective technical/business categories (e.g. selected when creating a SPINACT™ Account or during the present application process to be a Qualified Content Library contributor). The categorized application is then passed into the SPINACT™ Professional Credentialing System™ (shown in Step 152). Here, the Knowledge Producer's skills and expertise are evaluated against predetermined criteria relevant to their pre-selected technical/business category along with their relevant experience. In Step 152A, the Knowledge Marketplace System and software running thereon has been pre-programmed with the set of predetermined evaluation criteria relevant to the particular technical/business category to be used in evaluating the prospective Knowledge Producer. Accordingly, the Knowledge Marketplace System establishes and applies a unique set of evaluation criteria for each technical/business category. The filtering process ensures that the Knowledge Producer's application is directed into the appropriate technical/business category for evaluation. In some embodiments, as an example, the evaluation criteria may include without limitation level of education and/or types of degrees, years and type of relevant professional experience, level of positions held in industry and/or academia, awards or certificates, and/or other evaluation criteria relevant to each respective technical/business category. For example, in the IT area some representative evaluation criteria may be whether the Knowledge Producer candidate has a bachelors, masters, or doctorate degrees in computer science and/or engineering curriculum, whether the college/university is accredited by a national accreditation board, experience with various types of software or programming languages, etc. In some embodiments, a specialized reference check on the provided information may be performed in Knowledge Producer evaluation Step 152A using a Web service hosted on Web Applications Server 1 (FIG. 5) that links the Web server 1 to other existing Web services like LinkedIn™, Google™, etc. within the framework of Service Oriented Architecture (SOA) as depicted in FIG. 5 Internet Web Services 9.

With continuing reference to FIG. 16, a decision is made by the Knowledge Marketplace System in Step 152B whether the Knowledge Producer candidate meets the quality standards established by the System based on applying the evaluation criteria to the Knowledge Producer in Step 152A. The evaluation may be fully automated by the Knowledge Marketplace System based on objective evaluation criteria, or in some embodiments may be a combination of automated evaluation and human evaluation applying subjective criteria to the Knowledge Producer candidate's application to be a contributor to the SPINACT™ Qualified Content Library. If the Knowledge Producer candidate does not pass the evaluation (a “no” returned in Step 152B), the candidate is informed by the Knowledge Marketplace System such as via email. If the candidate passes the evaluation (a “yes” returned in Step 152B) and is selected as a quality Knowledge Producer, the qualified and selected candidate is then registered as a “Quality Knowledge Producer” on the system Database Server 3 (FIG. 5). Databases 15 contains a list of pre-qualified Knowledge Producers. In some embodiments, the Knowledge Marketplace System may also be operative to create an initial Knowledge Producer profile for the Knowledge Producer, which may be edited by the Knowledge Producer. The “Quality Knowledge Producers” may then produce knowledge content (Step 153) using Web-Portal A (FIG. 5) in the same manner already described herein with reference to FIG. 4 for submission to the Qualified Content Library shown in FIG. 2.

According to another aspect of the present invention, after the Knowledge Producer has been qualified or approved, the second part of the SPINACT™ quality system for creating content for the SPINACT™ Qualified Content Library is the knowledge content approval process further shown in FIG. 16 in Steps 154A through 159C. Step 154A illustrates the SPINACT™ Content Audit and Approval System. It should be noted that there are two possible routes in one embodiment for knowledge content to be identified for quality review and possible inclusion in the Qualified Content Library B12 shown in FIG. 2. In the first possible route, the Knowledge Producer may request a quality content review of his/her knowledge content information packet during the content upload process shown in FIG. 12. The upload content display screen in one embodiment may include a check box F780 which can be marked by the Knowledge Producer to apply for inclusion of the information packet into the Qualified Content Library B12. The Knowledge Marketplace System is operative to then create and associate an appropriate tag (metadata) with the knowledge content submission when the content is uploaded which will automatically trigger a content quality review at some point in time. Until the content has undergone quality review by the SPINACT™ Quality System, the uploaded knowledge content preferably will reside and be available for purchase and viewing by Knowledge Consumers in the Open Knowledge Marketplace B11 (FIG. 2).

A second possible route for inclusion of knowledge content information packets into the Qualified Content Library B12 shown in FIG. 2 may be initiated independently by the Knowledge Marketplace System without the Knowledge Producer requesting consideration during the knowledge content upload process of FIG. 12 as described above. In one possible embodiment, the quality review may be triggered based on user ratings (i.e. feedback from Knowledge Consumer) for a particular knowledge content information packet. Accordingly, if knowledge content being purchased and viewed in the Open Knowledge Marketplace B11 (FIG. 2) receives positive ratings from a number of users (see, e.g. ratings F92 in FIG. 14), the Knowledge Marketplace System may be operative retrieve and independently reviewing the knowledge content for inclusion in the Qualified Content Library. The review may be initiated based on a threshold number of users purchasing/viewing the knowledge content and those user's feedback on such quality metrics as price, content quality, relevance to the subject matter or topic addressed by the knowledge content, and/or other factors. The independent quality review is enabled by the user of the unique ID (metadata tag) assigned to every knowledge content uploaded onto the Knowledge Marketplace System as already described herein.

After a prospective knowledge content information packet has been identified for quality content review and approval by either of the foregoing two possible routes, the Knowledge Marketplace System in one embodiment first accesses the list of pre-qualified Knowledge Producer names stored in databases 15 to verify that the Knowledge Producer uploading the content is a known qualified and approved producer. If the Knowledge Producer is on the approved qualified Knowledge Producer list, the associated prospective knowledge content is then evaluated against the SPINACT™ Quality Metrics specifically designed for each technical/business category of knowledge content. These metrics or criteria may include price, content quality (e.g. completeness, level of detail, etc.), relevance to topic, and other appropriate metrics. Knowledge Consumer experiences and ratings of the knowledge content in the Open Knowledge Marketplace

B11 (FIG. 2) may also be considered during the evaluation and approval process. If in Step 154B the content does not meet predetermined quality criteria for content (“no” returned in Step 154B), the content submittal is rejected and the Knowledge Producer is notified such as via email. The Knowledge Producer's profile may also be updated to reflect the rejection of content. If the submitted content is approved (“yes” returned in Step 154B), the qualified knowledge content is then incorporated and posted into the SPINACT™ Qualified Content Library in Step 155, which may be stored in databases 15 accessible to the Database Server 3 (see FIG. 5) in some embodiments.

In a preferred embodiment, qualified knowledge content is displayed in search or browse results F84 to Knowledge Consumers as shown in FIG. 13 along with knowledge content that has not been qualified and is available for purchase in the Open Knowledge Marketplace B11 portion of the Knowledge Marketplace System (see FIG. 2). In FIG. 13, for example, the knowledge content information packet identified by icon F102 as “Subscribed” indicates that the packet is “qualified” and part of the SPINACT™ Qualified Content Library. Other alphanumerical and/or graphic indicia or designations may be displayed with the search or browse query results F84 to indicate which knowledge content is qualified in FIG. 13. In one embodiment preferred embodiment, all qualified knowledge content may be made available for purchase on a subscription basis in topical Category Buckets as further described herein.

According to another third aspect of the SPINACT™ Quality System, the Knowledge Marketplace System is operative to receive, process, organize, summarize, and display past user ratings of experiences with knowledge content information packets purchased and viewed by Knowledge Consumers from both the Open Knowledge Marketplace B11 and Qualified Content Library B12 (see FIG. 2). Steps 155A through 159C in FIG. 16 show the basic flow sequence of knowledge content rating and Knowledge Producer professional rankings. This flow sequence pertains all knowledge content in one embodiment regardless of whether the content is posted the Open Knowledge Marketplace 155B or Qualified Content Library 155A. After knowledge content is posted in Steps 155A or 155B, the Knowledge Consumer next purchases the content in Step 156 either on a Pay-Per-View basis or subscription basis as described above under “Knowledge Producer Process Flow” with reference to FIG. 3. In Step 157, the Knowledge Consumer views and may implement actions based on the knowledge content. Steps 156 and 157 in FIG. 16 illustrate and represent portions of Steps A38 and A39 in the Knowledge Consumer flow process discussed above under “Knowledge Consumer Process Flow” with reference to FIG. 3. Step 158A in FIG. 16 represents Step A312 in FIG. 3 in which the Knowledge Consumer rates and provides feedback on the knowledge content just purchased and reviewed and the associated Knowledge Producer. In Step 158 B in FIG. 16, the Knowledge Consumer rating for the purchased/viewed knowledge content is stored in database 15 and tracked by Database Server 3 (FIG. 5) according to the knowledge content unique ID (FIG. 14, F93) and the associated Knowledge Producers' unique ID automatically assigned by the Knowledge Marketplace System. The Knowledge Marketplace System is operative to compile, group, associate, and summarize all Knowledge Consumer ratings for each specific knowledge content information packet by unique ID and to display these content ratings to Knowledge Consumers in a webpage screen displays as shown in FIG. 14, item F92.

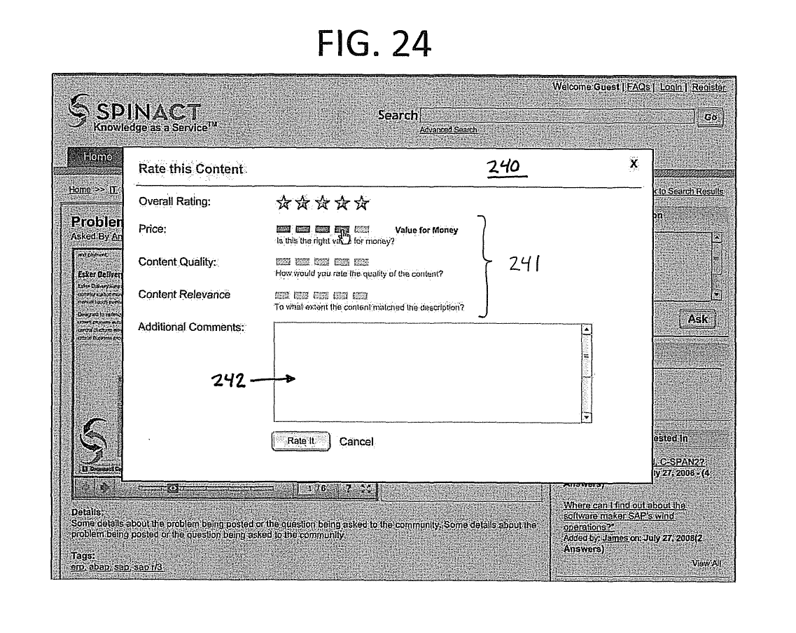

Referring to FIG. 24, when the Knowledge Consumer rates knowledge content as shown in Step A312 (FIG. 3) and Step A158 (FIG. 16), a webpage screen display 240 may be generated by the Knowledge Marketplace System through Web Portal A and used by the Knowledge Consumer to record their ratings and comments. In one possible embodiment, knowledge content information packets may be rated according to quality factors including without limitation price, content quality, content relevance to topic, and others. Display screen 240 may include data input fields 241 related to these quality factors using a scaled rating system to facilitate and standard rating data for knowledge content. A comments field 242 may be provided to allow the Knowledge Consumer to elaborate on their ratings. The Knowledge Consumer then clicks the “Rate It” or other similar button which uploads the knowledge content rating to the Knowledge Marketplace System. The Knowledge Marketplace System then functions in the manner described already to compile and store the Knowledge Consumer ratings for each knowledge content information packet.

Steps 159A-C in FIG. 16 illustrates the SPINACT™ Content and Professional Ranking System process performed by the Knowledge Marketplace System 100, which compiles and stores a plurality of Knowledge Consumer ratings of knowledge content and updates Knowledge Producer rankings based on feedback on their posted knowledge content. In Step 159A, the new knowledge content ratings are aggregated by the Knowledge Marketplace System with the existing ratings for the same content according to the unique knowledge content ID. As shown in FIG. 14 as an example, the ratings for a particular knowledge content information packet (e.g. Training Center content “SAP Training-Introduction to SAP DMS for Beginners” shown here) are summarized and displayed for the Knowledge Consumer in the knowledge content rating field F92. FIG. 14 shows a display screen generated by the Knowledge Marketplace System in response to a Knowledge Consumer selecting a single knowledge content information packet F91 to view detailed information of the content offering. The Knowledge Marketplace System then updates the knowledge content ratings and Knowledge Producer's rating in Step 159B in FIG. 16 based on user feedback. The results for the same are then updated against the Knowledge Producer's profile in Step 159C (see FIG. 13, F89 sample Knowledge Producer ratings/rankings) and posted back on the knowledge content Web-Portal A (FIG. 5).

After completion of Steps 159A-C shown in FIG. 16, the SPINACT™ Content and Professional Ranking System communicates the knowledge content back to the associated Knowledge Producer and any update/change in that Knowledge Producer's rating/ranking.

The Knowledge Marketplace System preferably deploys a workflow process and implements appropriately configured control logic and computer programs to automate the quality process implementation. As described herein, the Knowledge Marketplace System preferably is operative to integrate qualified third-party knowledge content produced by Knowledge Producers that may reside on other web servers in the distributed Internet domain into the SPINACT™ Content Library. This third-party knowledge content would be subjected to the same Quality System review as described herein for inclusion in the Qualified Content Library.

Integration of External Third-Party Knowledge Content

FIG. 15 illustrates one possible embodiment of a system configuration for integrating external third-party knowledge content from other distributed networks of Knowledge Producers on the Internet into SPINACT™ Knowledge Marketplace System and Qualified Content Library using XML based Open Application Programming Interfaces (API) over http and https protocols. Using their Internet access devices, Knowledge Consumers would log into Web Applications Server 1 of the Knowledge Marketplace System via Web Portal A in the usual manner (see also FIG. 5). The external knowledge content may be displayed to the Knowledge Consumer similarly to knowledge content F103 shown in FIG. 13 containing the same descriptions, pricing, and a unique knowledge content ID assigned automatically to the Content by the Knowledge Marketplace System. In some embodiments, however, the actual knowledge content or information may still reside in databases or computer readable medium on computers/servers external to the Knowledge Marketplace System but accessible via the Internet. Examples of such external third-party knowledge content may be online training courses offered by various Internet training organizations which would fall within the Training Center A215 category maintained by the Knowledge Marketplace System in the SPINACT™ Qualified Content Library. For example, in FIG. 13, the training knowledge content F100 on “Basic Project System (PS)” may actually reside on an external network. However, the Knowledge Marketplace System offers the content for viewing to the Knowledge Consumer regardless of where the content actually resides thereby creating a fully integrated system of available professional knowledge on any given topic.

With reference to FIGS. 5 and 15, when the Knowledge Consumer selects the foregoing external knowledge content for purchase and viewing, the Knowledge Marketplace System then processes and completes the payment/purchase of the external third-party knowledge content in the same manner described above and as shown in Step A39 of FIG. 3. Following payment processing (or alternatively verification of active valid subscription as described above, if applicable), the Knowledge Marketplace System is operative to initiate communications with and access third-party Internet Web Services 9 systems via their external web-portals 110 with open APIs via the Internet using XML based Open API with http and https protocols (see FIG. 5). The Knowledge Marketplace System, via Web Applications Server 1 shown in FIG. 5, retrieves and downloads the external knowledge content into its servers (such as Content Management Server 2 and/or Database Server 3) and may convert the Content to Adobe Flash if required to make the Content compatible for viewing on the Knowledge Consumer's Internet access device.

The Knowledge Consumer then views the contents of the external Qualified knowledge content from the third party through Web Applications Server 1 in the same manner already described elsewhere herein.

Knowledge Content Categories/Subscriptions (Step B13, FIG. 2)

According to another aspect of the invention shown in FIG. 2, as already mentioned herein, the Knowledge Marketplace System is operative to bundle and package individual knowledge content offerings or pre-packaged information packets residing in the “Qualified Content Library” into different user-subscribable technical/business categories by creating a plurality of Category Buckets F83 illustrated in FIG. 13. This allows a Knowledge Consumer to view a plurality of qualified knowledge content collected within a defined technical/business category for a single price. Such pricing may be advantageous to frequent users of the Knowledge Marketplace System. The “SPINACT™ Content Packaging System,” which in some embodiments may comprise processors operating in Database Server 3 and/or Content Management Server 2 (see FIG. 5), operates to organize and transfer the qualified knowledge content into these various pre-defined Category Bucket F83 according defined parameters preprogrammed into the control logic or software running on the Knowledge Marketplace System. The Category Buckets F83 may be defined within each technical/business category at the category and/or sub-category levels.

In some embodiments, the foregoing Category Buckets F83 (FIG. 13) may be priced for viewing by Knowledge Consumers on a periodic time basis, such as for example monthly, quarterly or yearly subscription rates. The Knowledge Consumers purchase subscriptions to a single or multiple Category Buckets F83 that provides them access to all the Qualified knowledge content in that Category Bucket. In one embodiment, referring to FIG. 13, the Knowledge Marketplace System is preferably operative to provide a visual indication (such as by an icon or indicia F102 “Subscribed” in one embodiment) to the Knowledge Consumer whether a particular knowledge content F103 displayed in search results F84 is covered by his/her existing subscriptions. The Category Bucket F83 pricing may vary by technical/business category, and further within each technical/business category by category and sub-category levels. Sub-category level pricing preferably is less than category level pricing because the number of individual knowledge content offerings available for viewing in a subscription to a Category Bucket at the sub-category level will be less than the number of offerings at the higher category level. It will be appreciated, however, that the subscription pricing for any given Category Bucket may be based on any number of factors because it will be market driven by Knowledge Consumers on a supply and demand basis. Accordingly, subscriptions to more popular Category Buckets in a very active technical/business area may be priced commensurately higher that Category Buckets in an infrequently used technical/business.

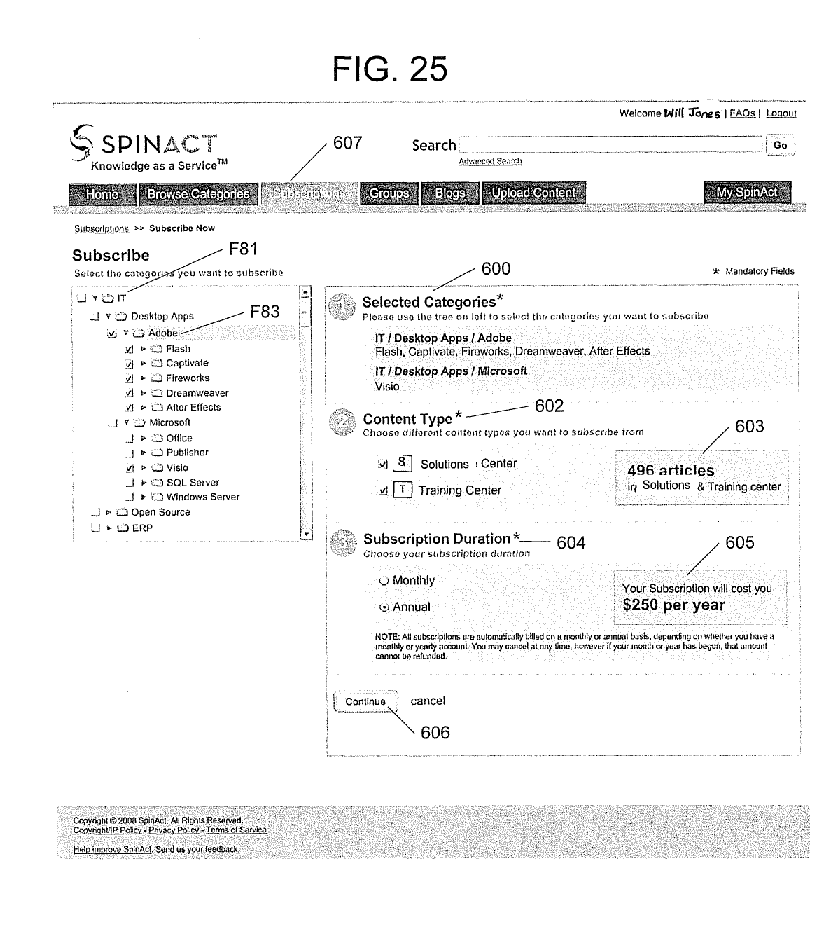

FIG. 25 shows an exemplary embodiment of a subscription GUI display screen that may be displayed in a webpage to a Knowledge Consumer. The Knowledge Consumer may be brought to this page by selecting the “Subscriptions” Tab or Tag 607, or alternatively in some embodiments by clicking on icon F102 “Subscribed” in FIG. 13 when viewing search or browse results F84 and considering purchasing knowledge content information packets 103. After the Knowledge Marketplace System generates the display screen in FIG. 25 in response to the foregoing Knowledge Consumer actions, the Knowledge Consumer selects topical categories of interest in a first step which are displayed in the “Selected Categories” field 600. In one embodiment, the categories may be selected by clicking on the topical Knowledge Categories F81 and Sub-Category tags F83 appearing in the category tree on the webpage display screen. The selected (marked) categories F81 and sub-categories F83 are then displayed in field 600. In the second step, the Knowledge Consumer may select which content types 602 are to be included in the subscription purchase. In one possible embodiment as shown, the available subscription choices may be Solutions Center A214 and Training Center A215 types of knowledge content information packets as already described herein. In other possible embodiments, Knowledge Center A216 type content and others may be displayed and available for subscription purchase. The total number of knowledge content information packets available for the content types selected may be displayed in field 603.

With continuing reference to FIG. 25, in the third step, the Knowledge Consumer may next select the subscription duration 604 which preferably is on a periodic basis, such as monthly or annually for example. The associated subscription cost 605 corresponding to the subscription duration 604 selected preferably is displayed to the Knowledge Consumer. Preferably, the Knowledge Marketplace System databases 15 includes a corresponding cost associated with each Category F81 and Sub-Category F83 and the associated content type 602 for which access rights may be granted. The unique IDs assigned to all knowledge content information packets allows the Knowledge Marketplace System to track and organize the content according to those parameters. To complete the online subscription purchase transaction, the Knowledge Consumer clicks the “Continue” button 606 or similar. The online payment processing may proceed in a manner already described herein.

Subscription Money Pool and Spinrate (Step B14, FIG. 2)

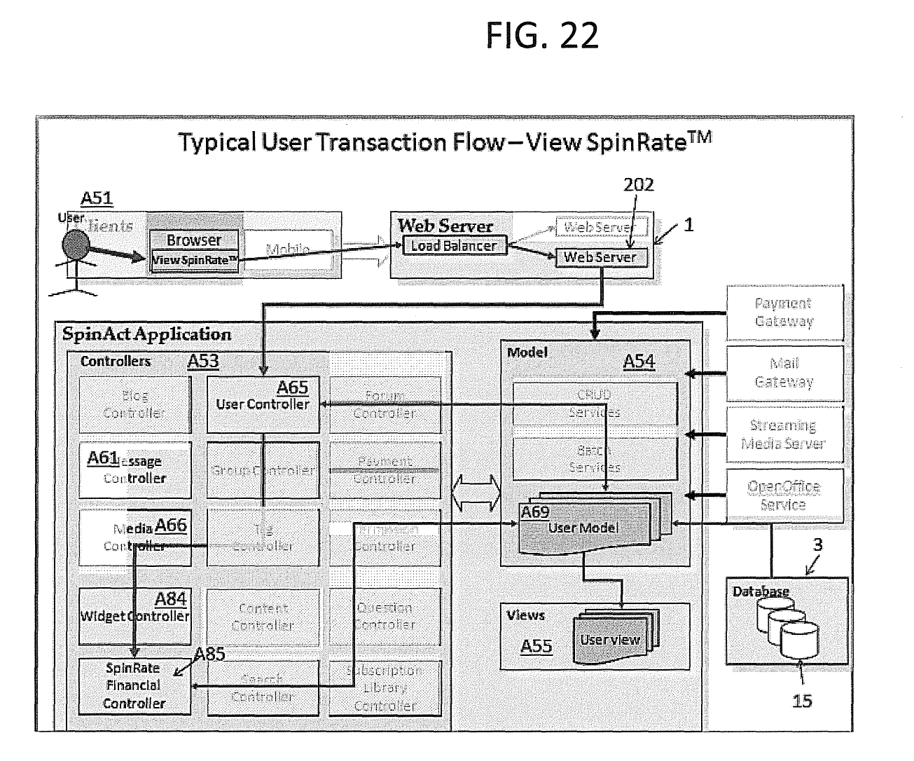

According to another aspect of the invention shown in FIG. 2, the Knowledge Marketplace System provides a revenue sharing mechanism for financially rewarding Knowledge Producers for their knowledge content purchased and viewed by Knowledge Consumers, thereby creating a true compensation-based market for professional knowledge exchange. As already described herein, Knowledge Consumers using the SPINACT™ Knowledge Marketplace System preferably may purchase knowledge content on an individual Content Pay-Per-View basis or by purchasing subscriptions to a Category Bucket F83 (see FIG. 13) within the Qualified Content Library. The Knowledge Marketplace System of the present invention operatively implements a unique financial reimbursement model for Knowledge Producers in the virtual online Knowledge Marketplace referred to herein as the “SpinRate™” system. In one embodiment, the SpinRate™ system may be implemented and operated via a SpinRate™ Financial Controller shown in FIG. 22 executing control logic and software operative to perform the financial-related data extractions and calculations as described herein. The discussion which follows describes the SpinRate™ system for distributing financial proceeds or revenues from subscriptions sold to Category Buckets of the Qualified Content Library.

For the purpose of describing the SpinRate™ financial system, the following definitions for various variables are defined below.

SpinRate™: defines the price index at which the sale of individual knowledge content by the Knowledge Consumer occurred in a given time period. The SpinRate™ is further used to reimburse Knowledge Producers as explained further herein. SpinRate™ is specific to a given “Category Bucket” and also is bound to fluctuate over time like a commodity stock price, due to variations in the demand and supply of knowledge content in a particular “Category Bucket”.

Subscription Pool: defines the sum of all earned subscription revenue or monies in a given “Category Bucket” over a fixed period of time for example day, week, month, etc. as some non limiting examples.

Withheld Subscription Revenue: defines a portion of the Subscription Pool revenue or monies withheld by the SPINACT™ Knowledge Marketplace System to account for changes in the Traffic Variant of Pay-Per-Views, and is determined by:

Withheld Subscription Revenue=Subscription Pool Revenue−(Subscription Pool Revenue×Traffic Variant)

Pay-Per-View: defines the number of times the Knowledge Consumers viewed knowledge content in a given “Category Bucket” over a fixed period of time for example day, week, month, etc. as some non limiting examples.

Traffic Variant: defines a variable factor that captures the variability of usage or Pay-Per-Views during some periods of time, when the activity in a Category Bucket is lower than normal due to abnormal factors not directly related to the market supply and demand of knowledge on the SPINACT™ Knowledge Marketplace System, such as for example holidays, other major business/financial market interruptions, Force Majeure of some kind, etc. In one embodiment, the maximum value for Traffic Variant is ‘1’ and the minimum value of Traffic Variant is ‘0’. The “Traffic Variant” goes down to fractional values lesser than ‘1’, as the Knowledge Marketplace System starts detecting the variability in Pay-Per-Views from a prior period of time. SPINACT™ Knowledge Marketplace System preferably includes and implements a traffic variability computational controller (e.g. controller A85 in FIG. 22) that will automatically adjust the value of Traffic Variant which may be based on many factors. In one embodiment, the Traffic Variant be based on changes in historical and current data related to factors including Pay-Per-View changes and number of subscribers for each Category Bucket. This is illustrated by way of the non-limiting examples given below.

The SpinRate™ for a given “Category Bucket” is calculated by following formula:

SpinRate™=((Subscription Pool+Withheld Subscription Pool)×(Traffic Variant))+Total Number of Pay-Per-Views

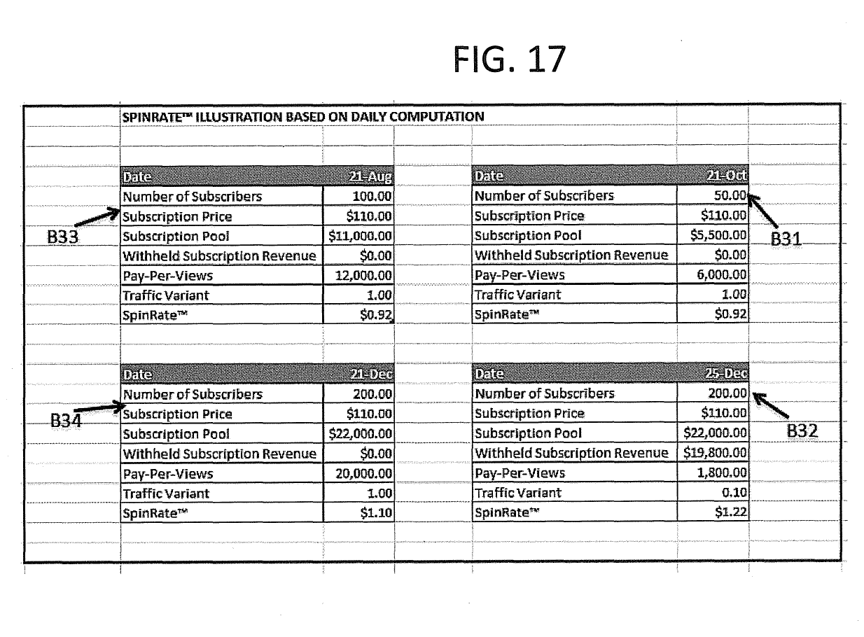

FIG. 17 below describes hypothetical examples of SpinRate™ calculations done on daily basis and compared over various periods of time. The SpinRate™ and related financial calculations described herein are preferably performed automatically by the Knowledge Marketplace System running appropriately configured programmable control logic or computer programs on the System computers/servers and using historical and current data collected/stored in databases 15. Accordingly, the Knowledge Marketplace System is operative to compile data and statistics related to finances (e.g. payments and subscriptions, etc.), system usage/traffic (e.g. Pay-Per-Views, number of subscribers, etc.), and other relevant factors as required, and then calculates financial compensation for Knowledge Producers using the formulas described herein. The Knowledge Marketplace System is further operative to display the results and variations in SpinRate™ to the Knowledge Producers, as well as calculate each Knowledge Producer's compensation for a given time period and communicate that information to the Knowledge Producer. The Knowledge Marketplace System is further operative to post the compensation into each Knowledge Producers SPINACT™ account.

In a first hypothetical example for a single Category Bucket with reference to FIG. 17, the number of Pay-Per-Views dropped significantly by 50% to 6,000 on October 21 (chart B31) from 12,000 on August 20 two months ago (Chart B33). In this case, however, the Traffic Variant did not change and remained the same at “1”. This is because there was a corresponding drop in the number of subscribers by 50% from 100 on August 21 to 50 on October 21. Therefore, the number of Pay-Per-Views would be expected to decrease by corresponding amount. The Withheld Subscription Revenue is “0.00” because the Traffic Variant is “1” calculated as follows:

Withheld Subscription Revenue=Subscription Pool−(Subscription Pool×Traffic Variant)=$5,500.00−($5,500.00×1)=$0.00

It should be noted that the number of Pay-Per-Views shown are for “subscription” Pay-Per-Views only under the Qualified Content Library Category Buckets and does not include individual or Pay-Per-View purchases by Knowledge Consumers on a non-subscription basis since these latter content purchases do not affect the subscription pool proceeds distribution to Knowledge Producers. The Knowledge Producers would be paid on a piece-meal basis for each non-subscription purchase based on the number of times their content is purchased. If the Knowledge Consumer has an existing subscription and clicked on knowledge content information packet that is part of their paid subscription, the Pay-Per-View charge would in fact be $0.00 when the “Buy Now” button (see FIG. 13) is clicked. However, the transaction is still tracked by the Knowledge Marketplace System to distribute subscription pool proceeds on a pro rata basis to Knowledge Producers.

In a second hypothetical example in FIG. 17 for a single Category Bucket, the number of Pay-Per-Views dropped significantly to 1,800 in chart B32 on December 25 (Christmas day) from 20,000 in chart B34 on December 21 four days earlier. The total number of 200 subscribers however remained the same on each date unlike the foregoing example. The Traffic Variant in this case drops to “0.10” on December 25, based on number of Pay-Per-Views on December 21 four days prior (i.e. 1,800 PPV÷20,000 PPV=0.09 or about 0.1 TV). Since the total number of subscribers to this particular Category Bucket remained unchanged on December 25 from December 21, the number of subscribers has no affect on the Traffic Variant. In some embodiments, other historical data collected over time by the SPINACT™ Knowledge Marketplace System may also be applied to determine the Traffic Variant. In this case with reference to charts B32 and B34, due to the Traffic Variant being less than “1”, the Withheld Subscription Revenue account receives proceeds in the amount of $19,800 (i.e. $22,000-$2,200) for December 25, as follows:

Withheld Subscription Revenue=Subscription Pool−(Subscription Pool×Traffic Variant)=$22,200.00−($22,000.00×0.1)=$19,800.00

This Withheld Subscription Revenue may then be spread out evenly across the immediate following monthly period (January). The Traffic Variant is intended to provide an equitable distribution of subscription pool revenues to all Knowledge Producers contributing content to a specific Category Bucket for “slow days” or periods, instead of only a few Knowledge Producers whose content was viewed on that slow day sharing a percentage of the large Subscription Pool for that day. It is anticipated that over time Traffic Variant factors would stabilize as the concept of the virtual online Knowledge Market matures and its adoption increases globally.

Please note the variation in SpinRate™ over the course of different days is purely attributable to the Subscriber Pool Money (Demand) and Pay-Per-Views of Knowledge Consumers. The volume of Pay-Per-Views will change significantly based on the volume of available knowledge content (Supply) in that “Category Bucket” by Knowledge Producers and the demand for such content by Knowledge Consumers. Also the use of a period, in this case “Day” is only for illustration purposes, the actual periods for calculating the SpinRate™ could be shorter (Hour, Minute, etc.) or longer (Week, Month, etc.).

Knowledge Producer Reimbursements

The Knowledge Producers will be reimbursed based on the total number of Pay-Per-Views of their specific knowledge content residing in a given Category Bucket that is viewed by Knowledge Consumers over the same period. For the purpose of illustrating Knowledge Producer revenue distribution, the following additional definitions for various variables are defined as follows:

Producer Reimbursement: The Producer Reimbursement is the rate at which Producers are compensated for every Pay-Per-View of knowledge content that is viewed by the subscribers of a given Category Buckets. If an individual Knowledge Producer has knowledge content that is not viewed by any Knowledge Consumer during a given time period, that Knowledge Producer does not receive any share of the subscription pool proceeds for that time period.

SPINACT™ Transaction Fee: The SPINACT™ Transaction Fee is a percentage value set by the Knowledge Marketplace System that is used to calculate the transaction cost for every Pay-Per-View. The SPINACT™ Transaction Fee is a variable that would be adjusted from time to time, based on market conditions, fixed costs, operating costs, and other factors. In some embodiments, the SPINACT™ Transaction Fee may also vary from one Knowledge Producer to another depending upon the volume of Pay-Per-Views attributable to an individual producer over a given period. This is akin to a volume transaction fee discount wherein Knowledge Producers having popular knowledge content which is viewed frequently by Knowledge Consumers (i.e. Pay-Per-Views) are charged a lower SPINACT™ Transaction Fee as a reward for producing knowledge content that has a higher volume of Pay-Per-Views. In some embodiments, the SPINACT™ Transaction Fee may also vary for a single Knowledge Producer from one Category Bucket to another Category Bucket wherein a Knowledge Producer's knowledge content in one professional technical/business area may be more popular than that same Knowledge Producer's Knowledge Consumer in another technical/business area.

The Producer Reimbursement in one embodiment may be calculated as defined by the following formula:

Producer Reimbursement (Per View)=Total Number of Pay-Per-Views×(SpinRate™×(1−SPINACT™ Transaction Fee))

As one example of how a Knowledge Producers would receive reimbursement under the Category Bucket subscription pool, it is initially assumed that the SPINACT™ Transaction Fee is set at 25% for a “Knowledge Producer A.” Using the daily computation of a SpinRate™ of $1.22 in chart B32 of FIG. 17 for December 25, reimbursement for Producer A in that case would be:

Producer A Reimbursement=Total Number of Producer A Pay-Per-Views×($1.22×(1−0.25))/View=Total Number of Producer A Pay-Per-Views×$0.915/View

If Producer A had 100 Pay-Per-Views total for December 25, compensation would be $91.50 (i.e. 100 Views×$0.915/View)

In another example, “Knowledge Producer B” is charged a discounted SPINACT™ Transaction Cost of only 20% as his knowledge content is more popular and has more Pay-Per-Views. The producer reimbursement for Producer B in that case would be:

Producer B Reimbursement=Total Number of Producer B Pay-Per-Views×($1.22×(1−0.20))=Total Number of Producer B Pay-Per-Views×$0.976/View

Thus the invention advantageously promotes and rewards higher performing producers, who in turn bring more traffic to their own Knowledge Consumer and in turn SPINACT™ Knowledge Marketplace. The Knowledge Producers with higher ratings and better quality content are going to perform better over others. Thus the invention advantageously builds a Self-Organizing and constantly improving Quality Knowledge Marketplace.

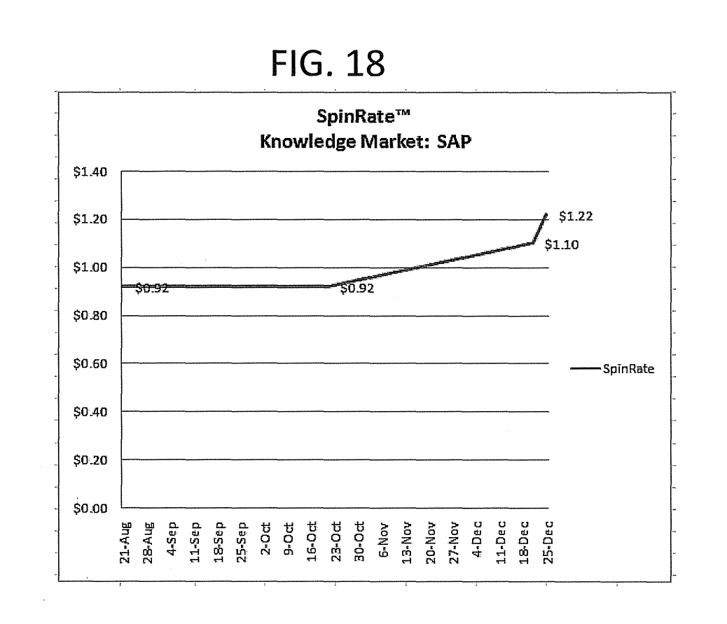

FIG. 18 shows an example of the hypothetical graphical trend of SpinRate™ plotted over time as also depicted in the Knowledge Producer display screen shown in FIG. 6 (see item F11). In this example, the Category Bucket is the sub-category “SAP” under “ERP” within the IT technical area. The volatility in SpinRate™ as illustrated by this example is driven drove by the supply and demand of knowledge content, forms the basis for trading Knowledge as a commodity. Thus, SpinRate™ will vary on a daily basis much like other financial commodity marketplaces, but instead trading knowledge as a product or commodity. Thus the invention advantageously builds the foundation of a virtual Knowledge Marketplace System to trade and exchanged professional knowledge and services. The Knowledge Producer's Account Summary F11 may also be shown in the display screen in FIG. 6 which indicates the amount of knowledge content purchases that have been made and credited to that Knowledge Producer's SPINACT™ account. In addition, each Knowledge Producer's statistics F16 may be displayed under “My Stats” in the display screen shown in FIG. 6 indicating the total number of open, draft, and resolved Knowledge Consumer questions addressed by that Knowledge Producer.

The foregoing describes the distribution of financial proceeds to Knowledge Producers from subscriptions sold to Category Buckets within the Qualified Content Library of the Knowledge Marketplace System. Any suitable method may be used to distribute financial proceeds to Knowledge Producers from knowledge content purchased and viewed on an individual non-subscription piecemeal Pay-Per-View basis by Knowledge Consumers. In one possible embodiment, the total Pay-Per-View cost may be distributed or credited to a Knowledge Producer's SPINACT™ account less a Non-Subscription Pay-Per-View transaction fee charged by the Knowledge Marketplace System (e.g. a fixed fee or percentage). Other suitable reimbursement/payment mechanisms may be used.

Other Web Portals

Another aspect of a preferred embodiment is to provide services to end users or Knowledge Consumers who are looking for professional services. In one embodiment, an online marketplace environment is provided (Portals C and E in FIG. 5) that invite the end user or Knowledge Consumer to search for Knowledge professionals in SPINACT™ database. The Knowledge Consumers can collaborate with the selected Professional by and initiating a live interactive session by using pre-existing infrastructure like Net Meeting, WebEx, and some of the newer on-demand web collaboration services like Yugma, etc. as some non limiting examples. The Knowledge Consumers can also post their inquiry about the services they are looking for, and then having the appropriate professionals contact them and start collaboration via the web portal framework (C, FIG. 5). The preferred embodiment may also include a scheduling process for scheduling professional meetings. According to another embodiment, the system may also invite project postings, project biddings and project networking by various service providers and consumers of professional services via the Internet which will be used to connect the professionals to the clients seeking services.

The preferred embodiment of the virtual Knowledge Marketplace System provides the necessary infrastructure support, including specific software and/or computer programs that are needed to achieve the same. The virtual professional Knowledge Marketplace System further provides a venue for posting technical or general business topics, project information for soliciting bids from professionals, etc.

According to one embodiment, the foregoing aspects of the invention may be provided using a collection of additional Web Portals hosted as Web Services on a Web Applications Server 1 as depicted in FIG. 5. These portals preferably may be:

On-Demand Applications Access Web Portal B;

On-Demand Services And Projects Professional Networking And Bidding C;

On-Demand Professional Web Seminars D; and

On-Demand Professional Service Consulting Portal E.

The foregoing Portals will be described below with reference to FIG. 5.

On-Demand Applications Access Web Portal B: This portal refers to the on-demand application access. Certain professional services will require access to certain application software, firmware or systems. This in turn will be hosted on a network of Applications Servers 5 as depicted in FIG. 5. The system access request from the user will be routed to a Citrix Web Server 4, (or any other commercially available software enabling multiple parallel user connections to the Applications Servers 5) which in turn will provide access to the Knowledge Producer user by making a secure connection to the Applications Server 5. The Citrix Webservice architecture accordingly will allow multiple parallel connections to the hosted applications on Application Server 5 by different Knowledge Consumers and Producers, recognizing that at different times a professional Knowledge Consumer may be professional Knowledge Producer and vice-versa. In certain other embodiments, it is contemplated that access to remote application servers, hosted on third party systems available over the Internet, may be accessed using the SPINACT™ Open Application Integration APIs as described herein.

On-Demand Services and Projects Professional Networking and Bidding Web Portal C: This portal will provide the single platform for Business consumers to post for service or project requests, invite professional bids on the service and project proposals, and provide framework for professional networking and creation of virtual project teams from global skill base. The service or project requests will be processed through the Portal C to the web services running on Web Applications Server 1.

On-Demand Professional Web Seminars Web Portal D: This portal will provide a real-time SPINACT™ Online Event Management services and seminars. The portal will host online seminars on specific categories or sub-categories. Different competing professional service firms will be invited to participate and host their professional service offerings on virtual booths. The Web-portal will provide SPINACT™ Virtual Seminar Simulation™ user interface that will provide almost virtual experience of visiting a conference or seminar. The Knowledge Consumers will have the option to attend live sessions presented on different topics of interest to them. The seminar participating Knowledge Producers (vendors) hosting the Web Seminars or Webinars and the Knowledge Consumers (buyers) could be located any place across the globe thus providing a global real-time on-demand seminar of professionals and professional service firms. Portal D will interact with the Real-Time Communication Server 6 and Web Applications Server 1 through Server 6 to connect the professional Knowledge Producers and Knowledge Consumers together.

On-Demand Professional Service Consulting Web Portal E: This portal provides browsable and searchable listing of professionals with their profiles, rankings and feedback through the Knowledge Marketplace System Web Applications Server 1. Portal E interacts real-time with Real-Time Communication Server 6, continuously updating the online status of Professionals. Portal E also routes the on-demand service requests placed by Knowledge Consumers through the Real-Time Communication Server 6 and Mobile Communication Server 7 to professionals, thereby enabling real-time communications between Knowledge Consumers and Knowledge Producers via conventional telecommunication channels (e.g. voice, text messaging, email, etc.). Portal E thus provides a central framework for scheduling, browsing, starting instant chat, communication, and/or Live sessions on Professional services using current infrastructure like Yugma, Goto Meeting, Webex, Windows Live Meeting, etc.

Knowledge Marketplace System Functional Components

FIG. 19 shows the Functional Components of one embodiment of the SPINACT™ Model View Control (MVC) System 200 for the Knowledge Marketplace System. The SPINACT™ Knowledge Marketplace System may be accessed using any web browser/client (A51). The client requests are processed by the Web Applications Server 1 (also depicted in FIG. 5). Web Applications Server 1 will run a Load Balancer 201 to distribute the client request loads evenly to multiple web servers 202 running in parallel. The various controllers built for the SPINACT™ application are collectively represented as item A53. The controllers each manage the flow of data and communication in the SPINACT™ application related to various functions performed by the Knowledge Marketplace System. The controllers interact with the Model (A54) that stores all database commit, read, update, and delete (CRUD) Services and the User Views (A55) as referred to earlier as Web Portals A-E in FIG. 5. Model A54 represents the information/data of the SPINACT™ application and algorithms used to manipulate the information/data. Item A56 collectively represents the Payment Gateway, Mail Gateway, Streaming Media Server and Open Office Services. The Payment gateway functions to assist with helping in processing payments with third party applications like PayPal, Amex, etc. as some non limiting examples. The Mail Gateway functions to assist with helping in procesing the SPINACT™ Mail System. The Steaming Media Server functions to assist with helping in streaming knowledge content. The SPINACT™ system deploys conventional OpenOffice conversion services to convert different document formats to FLV (Flash) format. Database Server 3 and databases 15 which manages and stores respectively the information and data already described herein are shown as they related to Model A56.

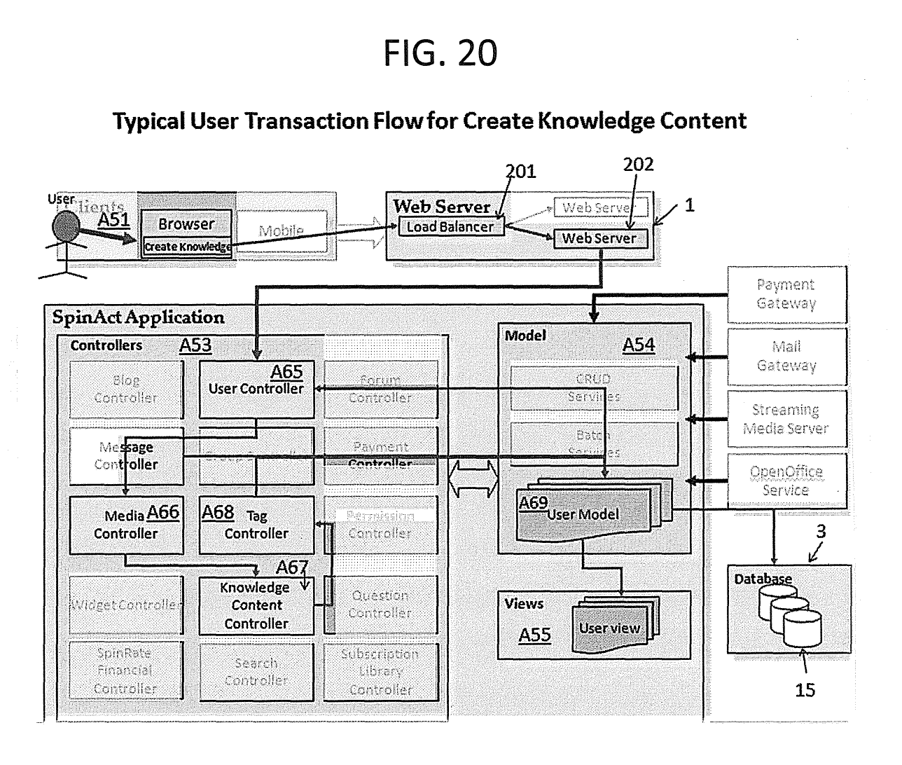

FIG. 20 shows a typical transaction flow and control logic for a Knowledge Producer to create knowledge content. The Knowledge Producer inputs a “create knowledge content” request into a GUI display screen A62 (such as shown in FIG. 12) from the browser/client A51 which is passed on to the load balancer 201 in Web Applications Server 1, which further delineates the request to one of the Web Servers 202. The request may be in the form of a data packet signal processed through the Knowledge Marketplace System. The request from the Web Server 202 is first passed to the User Controller A65, then relayed to the message controller A61 and media controller A66. From there, the request flows to the knowledge content Controller A67 and Tag Controller A68. The requests are further handled and processed by the Model A54 and appropriate User views (GUI) A55 are generated by the Knowledge Marketplace System (in this case Upload Content display screen FIG. 12) and the System downloads the knowledge content to the Database Server 3 where the knowledge content is stored via accessible databases 15.

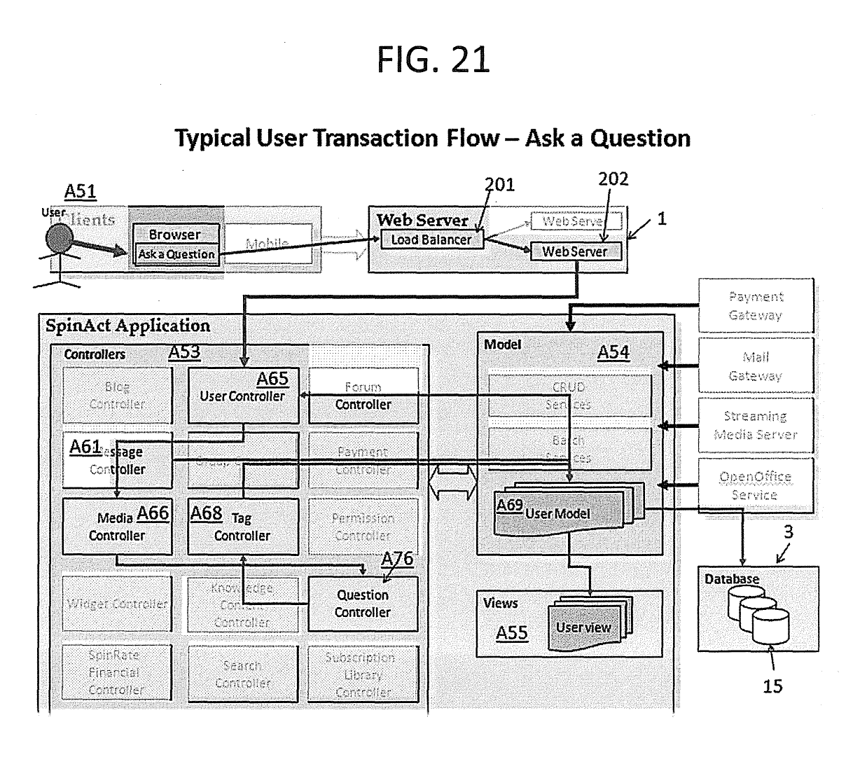

FIG. 21 shows a typical transaction flow and control logic for a Knowledge Query request (“Ask a Question”) input into the Knowledge Marketplace System by a Knowledge Consumer. The request is received and processed by Web Applications Server 1 and transmitted to message controller A61 and media controller A66 in the same manner as just described above for FIG. 20. From media controller A66, the Knowledge Query request is relayed to question controller A76 and then to tag controller A68. The requests are further handled and processed by the Model A54 and appropriate User views (GUI) A55 are generated by the Knowledge Marketplace System (in this case Ask a Question display screen FIG. 11) and the Query request is downloaded to the Database Server 3.

FIG. 22 shows a typical transaction flow and control logic for a view SpinRate™ request input into the Knowledge Marketplace System by a Knowledge Producer. The request is received and processed by Web Applications Server 1 in the same manner as described above for FIG. 20 and then transmitted to media controller A66. From media controller A66, the SpinRate™ request is relayed to widget controller A84 and then to SpinRate™ financial controller A85. The SpinRate™ request is then further handled and processed by the Model A54 and appropriate User views (GUI) A55 are generated by the Knowledge Marketplace System (in this case Knowledge Producer display screen FIG. 6). The request is processed by Database Server 3 which retrieves requested SpinRate™ from databases 15 and displays a view of the SpinRate™ to the Knowledge Producer such as in item F11 shown in FIG. 6.

It is contemplated that some aspects of the Knowledge Marketplace System described herein may require intervention by personnel responsible for programming, monitoring, maintaining, and operating the System. For example, without limitation, portions of SPINACT™ Quality System shown in FIG. 16 may require human intervention for qualifying Knowledge Producers and/or qualifying their submitted knowledge content/information packets for potential inclusion in the Qualified Content Library.

While the foregoing description and drawings represent preferred or exemplary embodiments of the present invention, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. In addition, numerous variations in the preferred or exemplary methods and processes described herein may be made without departing from the spirit of the invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. An Internet-based on-demand virtual knowledge marketplace system for professionals implemented via a Web-based computer and communication network, the system comprising:
a host computer network including a database accessible to the network that contains a plurality of pre-packaged information packets browsable via a first remote computer by a knowledge consumer through a Web portal;
a communications network linking the first remote computer to the host computer network;
each information packet containing information related to a professional topic or subject matter, the information packets comprising at least one each of a first packet associated with a first type of professional knowledge content and a second packet associated with a second type of professional knowledge content;
each information packet having an associated purchase price;
wherein the system is operative to enable the knowledge consumer to preview, select, and purchase an information packet online for viewing in real time over the Internet.

2. The system of claim 1, wherein the first information packet contains short answer type professional knowledge content and the second information packet contains professional training type knowledge content.

3. The system of claim 1, further comprising a third information packet associated with a third type of professional knowledge content.

4. The system of claim 3, wherein the third information packet contains standard service solutions type professional knowledge content.

5. The system of claim 1, further comprising a database server connected to the computer network and operative to access the database, the database server operative via executing software to sort and organize the information packets into one of a knowledge center, a solutions center, and a training center.

6. The system of claim 5, wherein the host computer network is operative to organize and display the information packets to the knowledge consumer in a webpage grouped according to the knowledge, solutions, and training centers.

7. The system of claim 1, wherein a list of available information packets is generated by the host computer network in response to a query input into the system by a knowledge consumer, the list of information packets including the first and second types of professional knowledge content;

8. The system of claim 1, wherein the communications network is the Internet.

9. The system of claim 1, wherein the information packet is purchased by the knowledge consumer on a subscription basis that provides the knowledge consumer with access to view a plurality of information packets associated with a single topical technical or business category for a limited period of time and for a single purchase price.

10. The system of claim 1, wherein the information packet is purchased by the knowledge consumer on a single pay-per-view basis.

11. The system of claim 1, wherein the host computer network executes programmable control logic that enables Semantic searching and retrieval of results related to available information packets accessible to the network in real time as a knowledge consumer browses or searches for information packets on a particular topic.

12. The system of claim 1, wherein the system is further operative to both display previews of information packets residing in online third-part computer networks accessible via the Internet and to retrieve the third-party information packets via application programming interfaces.

13. The system of claim 1, wherein the information packets contain professional knowledge content related to information technology and systems.

14. The system of claim 1, wherein the system is further operative to convert the information packets to flash format for standardized viewing by knowledge consumers.

15. The system of claim 1, wherein each information packet is created and uploaded into the database by a pre-qualified knowledge producer that has been approved in advance for uploading and selling knowledge content on the system.

16. The system of claim 1, further comprising database and content management servers accessible to the host computer network and being operative to sort, organize, and display the information packets grouped into the at least first and second types of professional knowledge content in the Web portal.

17. The system of claim 1, wherein the information packets are organized into a plurality of topical category buckets each having a pre-defined collection of more than one information packet related to a single topical category, the system offering access for viewing all information packets in a category bucket on a subscription basis.

18. An Internet-based on-demand virtual knowledge marketplace system for professionals implemented via a Web-based computer and communication network, the system comprising:
a host computer network including a database server connected to database containing an online knowledge content library storing a plurality of pre-packaged information packets of professional knowledge content browsable via a first remote computer by a knowledge consumer through a Web portal;
the information packets being uploaded to the system by a knowledge producer and having an associated viewing price and content type tag designated by the knowledge producer for their respective information packet; and
a communications network linking the first remote computer to the host computer network;
wherein the database server is operative to:
receive a search or browse request from the knowledge consumer;
retrieve one or more previews of information packets from the online knowledge content library responsive to the knowledge consumer request; and
display the one or more information packet previews in the Web portal to the knowledge consumer with the associated content type tag designation.

19. The system of claim 18, wherein the system is operative to organize the information packets according to two or more types of knowledge content.

20. The system of claim 19, wherein content types include professional service solutions, professional short answers, and a professional training.

21. The system of claim 18, wherein the information packets are grouped under tabs in a graphical user interface display screen having labels including knowledge center, solution center, and training center.

22. The system of claim 18, wherein the system is further operative to: receive and process an online payment from the knowledge consumer to purchase viewing rights to one of the information packets; retrieve a full version of the information packet from the online knowledge content library; and display the full version of the information packet in the Web portal for viewing in real time over the Internet.

23. The system of claim 18, wherein each information packet preview includes associated user ratings.

24. The system, of claim 18, wherein the information packets are uploaded to the system by knowledge producers that are pre-qualified based on meeting a set of credentialing criteria.

25. The system of claim 18, wherein the credentialing criteria include education and actual work experience.

26. The system of claim 18, wherein the information packets are incorporated into a qualified content library residing in the database, all information packets undergoing evaluation against a set of quality metrics and being approved prior to inclusion in the library.

27. The system of claim 18, wherein the system if further operative to convert the uploaded information packets into flash format for viewing by knowledge consumers regardless of the type of software used to create the information packets.

28. A method implemented by a Web-based computer and communication network for exchanging professional information via the Internet in an online virtual knowledge marketplace, the method comprising:
providing a host computer and communication network operative to exchange information via the Internet between a plurality of knowledge producers and knowledge consumers;
storing in a database accessible to the network a plurality of knowledge content information packets uploaded to the network by a plurality of knowledge producers, each information packet having an associated knowledge content type selected from one of at least two content types and an associated viewing price;
receiving a selection request from a knowledge consumer to purchase and view one of the information packets;
processing an online payment by the knowledge consumer for the selected information packet;
retrieving the selected information packet from the database; and
displaying the selected information packet in a Webpage to the knowledge consumer.

29. The method of claim 28, wherein the information packets uploaded to the system are prepared by pre-qualified knowledge producers which have met a set of credentialing criteria.

30. The method of claim 28, further comprising sorting the plurality of knowledge content information packets uploaded to the network into the at least two knowledge content types and displaying the information packets available for purchase by a knowledge consumer grouped into the at least two knowledge content types.

31. The method of claim 30, wherein the knowledge content types include professional service solution packets, a professional short answer packets, and professional training packets.

32. The method of claim 28, further comprising receiving an information packet upload requests from a knowledge producer and confirming in a list of pre-qualified knowledge producer names residing in the database that the knowledge producer is pre-approved for submitting information packets.

33. The method of claim 32, further comprising evaluating the information packet of the upload request against a set of quality metrics for possible inclusion of the information packet in a qualified content library residing in the database.

34. The method of claim 28, wherein the knowledge producer sets the associated viewing price for the selected information packet.

35. The method of claim 28, further comprising receiving a browse or search request from a knowledge consumer, retrieving a plurality of previews of information packets from the database responsive to the browse or search request, and displaying the previews in a Web portal to the knowledge consumer.

36. The method of claim 35, further comprising organizing the previews in the Web portal according to the at least two knowledge content types.

37. A method implemented by a Web-based computer and communication network for exchanging professional information via the Internet in an online virtual knowledge marketplace, the method comprising:
providing a host computer and communication network operative to establish two-way communications via the Internet between a plurality of knowledge consumers and professional knowledge producers;
receiving a question from a knowledge consumer over the network containing a request for professional knowledge assistance;
displaying the question to a plurality of knowledge producers over the network;
receiving a knowledge content offering responsive to the question from at least one of the knowledge producers; and
transmitting the responsive knowledge content offering to the knowledge consumer generating the question with an associated purchase price, wherein the knowledge consumer may purchase and view the knowledge content in real time over the Internet.

38. The method of claim 37, further comprising the network assigning a unique question ID to the question from the knowledge consumer.

39. The method of claim 38, further comprising receiving a plurality of knowledge content offerings from knowledge producers, associating the knowledge content offerings with the question ID, and displaying all the knowledge content offerings associated with the question ID in a Web page.

40. A computer-implemented interactive on-line knowledge content exchange system accessible via the Internet to a plurality of knowledge buyers and knowledge producers, the system comprising:
a host computer network having a web applications server providing a Web portal and a database accessible to the network that contains:
an online knowledge content library browsable via remote computers through the Web portal and including a plurality of pre-qualified knowledge content packets that have met a set of quality metrics necessary for inclusion of the content packet in the library; and
names of pre-qualified knowledge producers associated with each information packet that has met a set of credentialing criteria necessary to create and upload the information packets into the library;
wherein the system is operative to enable a plurality of knowledge buyers to browse the online content library and purchase knowledge content packets from the library for viewing at a price established by each knowledge producer for their respective content packet.

41. An Internet-based on-demand virtual knowledge marketplace system for professionals implemented via a Web-based computer and communication network, the system comprising:
a host computer network;
a communications network linking a plurality of remote knowledge consumer Internet access devices to the host computer network;
at least one database accessible to the host computer network and storing a plurality of pre-packaged knowledge content information packets browsable via the remote Internet access devices through a Web portal, the information packets being uploaded to the system by a plurality of knowledge producer, each infoimation packet having an associated viewing price designated by the knowledge producer for allowing viewing of their respective information packet; and
wherein the host computer network is operative to:
select at least some of the information packets;
compare the selected information packets against a set of quality content criteria; and
designate selected information packets meeting the criteria as qualified content.

42. The system of claim 41, wherein some of the information packets belong to a first group of qualified knowledge content having undergone and passed a quality content review, and some of the information packets belong to a second group of knowledge content which have either not undergone a quality content review or have not passed the quality content review.
